(19) United States
(12) Patent Application Publication
(10) Pub. No.: US 2017/0110083 A1
(43) Pub. Date: Apr. 20, 2017

(54) INFORMATION PROCESSING SYSTEM, METHOD FOR PROCESSING INFORMATION, AND COMPUTER PROGRAM PRODUCT

(71) Applicants: Shinsuke YANAZUME, Tokyo (JP); Shigeyuki ISHII, Kanagawa (JP)

(72) Inventors: Shinsuke YANAZUME, Tokyo (JP); Shigeyuki ISHII, Kanagawa (JP)

(73) Assignee: RICOH COMPANY, LTD., Tokyo (JP)

(21) Appl. No.: 15/291,315

(22) Filed: Oct. 12, 2016

(30) Foreign Application Priority Data
Oct. 15, 2015 (JP) 2015-204107
Mar. 28, 2016 (JP) 2016-064444

(51) Int. Cl. G09G 5/00; G06F 3/0484; G06F 3/03; G06F 3/033; G09G 5/373; G09G 5/38

(52) U.S. Cl. CPC G09G 5/003; G09G 5/373; G09G 5/38; G06F 3/0304; G06F 3/033; G06F 3/04842; G09G 2370/16; G09G 2370/025; G09G 2320/0626; G09G 3/002

(57) ABSTRACT

The information processing apparatus includes an image information sender configured to send, to the display device, part-selecting image information provided for displaying a part-selecting image including one or more display parts, and a function executing instruction sender configured to send, to the display device, a function executing instruction executing a function corresponding to one of the one or more display parts, the one of the one or more display parts being specified by an instructing operation performed on the part-selecting image displayed on a display by the display device. The display device includes a display controller configured to display the part-selecting image on the display, based on part-selecting image information received from the information processing apparatus and a function executor configured to execute the function in accordance with a function executing instruction received from the information processing apparatus.

### CROSS-REFERENCE TO RELATED APPLICATIONS

The present application claims the benefit of priority under 35 U.S.C. §119 of Japanese Patent Applications No. 2015-204107, filed Oct. 15, 2015, and No. 2016-064444, filed Mar. 28, 2016, the contents of which are incorporated herein by reference in their entirety.

### BACKGROUND OF THE INVENTION

1. Field of the Invention

The present disclosure relates to information processing systems, methods for processing information, and computer program products.

2. Description of the Related Art

Conventionally, regarding display devices such as projectors and electronic blackboards, there has been a technique that expands operation methods for executing functions by way of interactive operations.

### SUMMARY OF THE INVENTION

In order to attend to such above-described problems, one aspect of the present invention provides an information processing system including an information processing apparatus and a display device. The information processing apparatus includes an image information sender configured to send, to the display device, part-selecting image information provided for displaying a part-selecting image including one or more display parts, and a function executing instruction sender configured to send, to the display device, a function executing instruction for executing a function corresponding to one of the one or more display parts, the one of the one or more display parts being specified by an instructing operation performed on the part-selecting image displayed on a display by the display device. The display device includes an image information receiver configured to receive the part-selecting image information from the information processing apparatus, a display controller configured to display the part-selecting image on the display, based on the received part-selecting image information, a function executing instruction receiver configured to receive the function executing instruction from the information processing apparatus, and a function executor configured to execute the function in accordance with the received function executing instruction.

### BRIEF DESCRIPTION OF THE DRAWINGS

FIG. 1 is a block diagram illustrating an example of a configuration of an information processing system according to a first embodiment;

FIG. 2 is a block diagram illustrating an example of a hardware configuration of an information processing apparatus according to the first embodiment;

FIG. 3 is a block diagram illustrating an example of a hardware configuration of a display device according to the first embodiment;

FIG. 4 is a block diagram illustrating an example of a functional configuration of the information processing system according to the first embodiment;

FIG. 5 is a drawing illustrating an example of a part-selecting image according to the first embodiment;

FIG. 6 is a drawing illustrating an example of information stored in image information storage according to the first embodiment;

FIG. 7 is a drawing illustrating an example of information stored in function identifying information storage according to the first embodiment;

FIG. 8 is a sequence diagram illustrating an example of image projecting processing performed in the information processing system according to the first embodiment;

FIG. 9 is a flowchart illustrating an example of processing for confirming an instructing operation performed in the information processing system according to the first embodiment;

FIG. 10 is a sequence diagram illustrating an example of function executing processing performed in the information processing system according to the first embodiment;

FIG. 11 is a block diagram illustrating an example of a functional configuration of an information processing system according to a second embodiment;

FIG. 12 is a drawing illustrating an example of a part-selecting image according to the second embodiment;

FIG. 13 is a drawing illustrating an example of the part-selecting image according to the second embodiment;

FIG. 14 is a drawing illustrating an example of information stored in image information storage according to the second embodiment;

FIG. 15 is a sequence diagram illustrating an example of image projecting processing performed in the information processing system according to the second embodiment;

FIG. 16 is a block diagram illustrating an example of a functional configuration of an information processing system according to a third embodiment;

FIG. 17 is a drawing illustrating an example of a part-selecting image according to the third embodiment;

FIG. 18 is a drawing illustrating an example of the part-selecting image according to the third embodiment;

FIG. 19 is a drawing illustrating an example of information stored in image information storage according to the third embodiment;

FIG. 20 is a sequence diagram illustrating an example of image projecting processing performed in the information processing system according to the third embodiment;

FIG. 21 is a flowchart illustrating an example of mode-change detecting processing performed in a display device according to the third embodiment;

FIG. 22 is a sequence diagram illustrating an example of the image projecting processing performed in the information processing system according to the third embodiment, in a case where a mode of the display device is updated;

FIG. 23 is a block diagram illustrating an example of a functional configuration of an information processing system according to a fourth embodiment;

FIG. 24 is a drawing illustrating an example of a part-selecting image according to the fourth embodiment;

FIG. 25 is a drawing illustrating an example of the part-selecting image according to the fourth embodiment;

FIG. 26 is a sequence diagram illustrating an example of function executing processing performed in the information processing system according to the fourth embodiment;

FIG. 27 is a block diagram illustrating an example of a functional configuration of an information processing system according to a fifth embodiment;

FIG. 28 is a drawing for explaining an example of a determining method according to the fifth embodiment;

FIG. 29 is a drawing illustrating an example of a display image according to the fifth embodiment;

FIG. 30 is a flowchart illustrating an example of processing for confirming an instructing operation performed in the information processing system according to the fifth embodiment;

FIG. 31 is a sequence diagram illustrating an example of image projecting processing performed in the information processing system according to the fifth embodiment, in a case where a size of a part-selecting image is smaller than a threshold value;

FIG. 32 is a block diagram illustrating an example of a functional configuration of an information processing system according to a sixth embodiment;

FIGS. 33A and 33B are drawings illustrating examples of a part-selecting image according to the sixth embodiment;

FIG. 34 is a sequence diagram illustrating an example of image projecting processing performed in the information processing system according to the sixth embodiment;

FIG. 35 is a block diagram illustrating an example of a hardware configuration of an information processing apparatus according to a seventh embodiment;

FIG. 36 is a block diagram illustrating an example of a functional configuration of an information processing system according to the seventh embodiment;

FIGS. 37A and 37B are drawings illustrating examples of a part-selecting image according to the seventh embodiment;

FIG. 38 is a sequence diagram illustrating an example of image projecting processing performed in the information processing system according to the seventh embodiment;

FIG. 39 is a block diagram illustrating an example of a functional configuration of an information processing system according to an eighth embodiment;

FIGS. 40A and 40B are drawings illustrating examples of a part-selecting image according to the eighth embodiment;

FIG. 41 is a sequence diagram illustrating an example of image projecting processing performed in the information processing system according to the eighth embodiment;

FIG. 42 is a block diagram illustrating an example of a functional configuration of an information processing system according to a ninth embodiment;

FIG. 43 is a sequence diagram illustrating an example of image projecting processing performed in the information processing system according to the ninth embodiment;

FIG. 44 is a block diagram illustrating an example of a functional configuration of an information processing system according to a tenth embodiment; and

FIG. 45 is a sequence diagram illustrating an example of image projecting processing performed in the information processing system according to the tenth embodiment.

### DESCRIPTION OF THE EMBODIMENTS

Expansion of operation methods for executing functions is not easily applicable to some display devices due to problems relating to complexity of ways of expanding operation methods, such as, as a physical matter, a display device may require en operation sheet for expanding operation methods for executing functions, and a display device may need to manage part-selecting images, which include display parts provided for expanding operation methods of the display device, and may also need to specify functions to be executed.

In order to attend to such above-described problems, the present invention provides an information processing system, a method for processing information, and a computer program product, which enable various display devices to expand operation methods for executing functions.

In the following, embodiments of an information processing system, a method for processing information, and a computer program product according to the present invention will be explained in detail, with reference to accompanying drawings.

### First Embodiment

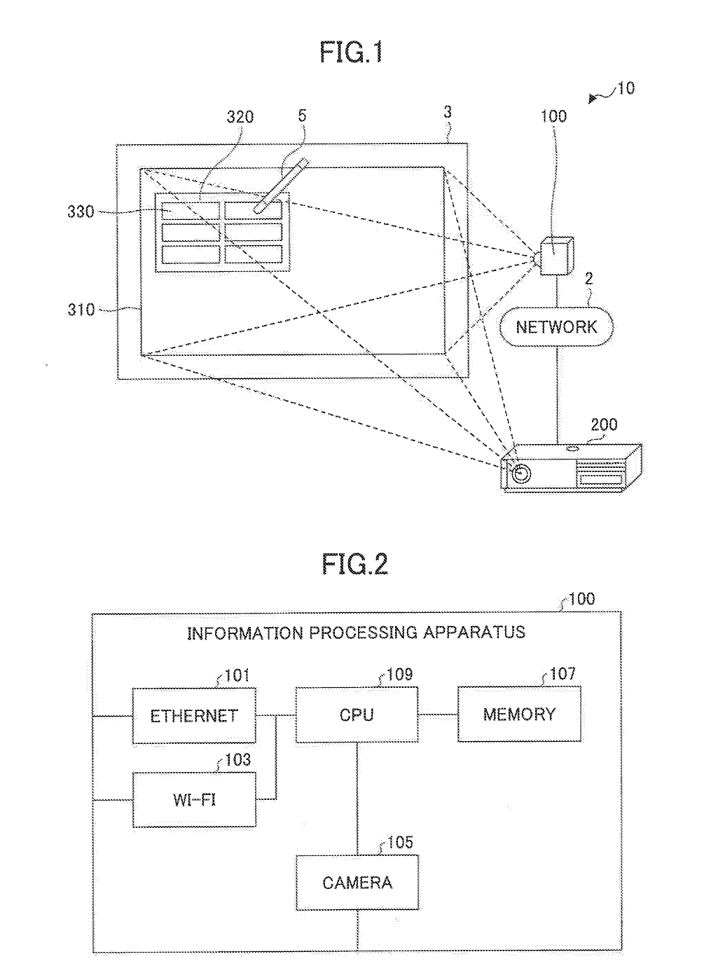

FIG. 1 is a block diagram illustrating an example of a configuration of an information processing system 10 according to the first embodiment. As illustrated in FIG. 1, the information processing system 10 includes an information processing apparatus 100 and a display device 200.

The information processing apparatus 100 and the display device 200 are connected via a network 2. Although a wireless Local Area Network (LAN) is taken as an example of the network 2 in the following explanation of the first embodiment, the network 2 is not limited to a wireless LAN, and may be, for example, a wired LAN. Further, the connection between the information processing apparatus 100 and the display device 200 is not necessarily via the network 2, and may be, for example, through a predetermined communication standard such as a Universal Serial Pus (USB).

In the explanation of the first embodiment, a projector is taken as an example of the display device 200. Here, any types of projectors, for example, a Digital Light Processing (DLP) projector, etc., will do. Further, the display device 200 is not necessarily a projector, and may be, for example, an electronic whiteboard.

The display device 200 displays (projects) a display image 310 on a display 3. The display 3 may be, but not limited to, a screen, a wall surface (although a wall surface of white or whitish color is preferable), and a whiteboard. In the example illustrated in FIG. 1, a display image 310 which includes a part-selecting image 320 having one or more display parts 330 (also referred to as display Parts 330-1 through 330-6 when differentiated) is displayed on the display 3. Here, the display parts 330 are assumed to be, but not limited to, symbols such as electronic buttons and icons. The details of the display parts 330, the part-selecting image 320, and the display image 310 will later be described.

An instructing operation device 5 may be an operation device in a shape of a pen or a stick that a user holds an his/her hand. The instructing operation device 5 is used by a user for performing an instructing operation on the display image 310 displayed on the display 3. An instructing operation is an operation of pointing at a position on the display image 310 displayed on the display 3 with the instructing operation device 5. Here, a position on which an instructing operation is performed (i.e. a position pointed at in an instructing operation) is referred to as an instructing operation point.

Although, in the explanation of the first embodiment, an operation of directly pointing at (or touching) an instructing operation point with the tip of the instructing operation device 5 is taken as an example of the instructing operation, the instructing operation is not limited to such an operation, and may be, for example, an operation of pointing at an instructing operation point with a laser in a case where the instructing operation device 5 is a laser pointer.

The information processing apparatus 100 detects an instructing operation point on the display image 310 displayed on the display 3 where an instruction operation is performed by use of the instructing operation device 5. Then, in a case were there is a display part 330 at the detected instructing operation point, the information processing apparatus 100 instructs the display device 200 to execute a function that corresponds to the display part 330. In such a way, the display device 200 executes a function, among all functions of the display device 200, according to the instruction from the information processing apparatus 100.

FIG. 2 is a block diagram illustrating an example of a hardware configuration of the information processing apparatus 100 according to the first embodiment. As illustrated in FIG. 2, the information processing apparatus 100 includes an Ethernet (registered trademark; hereinafter omitted) 101, a Wi-Fi (registered trademark; hereinafter omitted) 103, a camera 105, a memory 107, and central processing unit (CPU) 109.

The Ethernet 101 is a communication interface to a wired. LAN. The Wi-Fi 103 is a communication interface to a wireless LAN. The camera 105 is a vision sensor for capturing the display image 310 displayed on the display 3. The memory 107 stores various types of information utilized by the CPU 109. The CPU 109 controls each part of the information processing apparatus 100.

Here, the information processing apparatus 100 may further include an external storing device such as a hard disk drive (HDD), and, may be configured to be connectable to an external memory and an external storing device via a USB, etc.

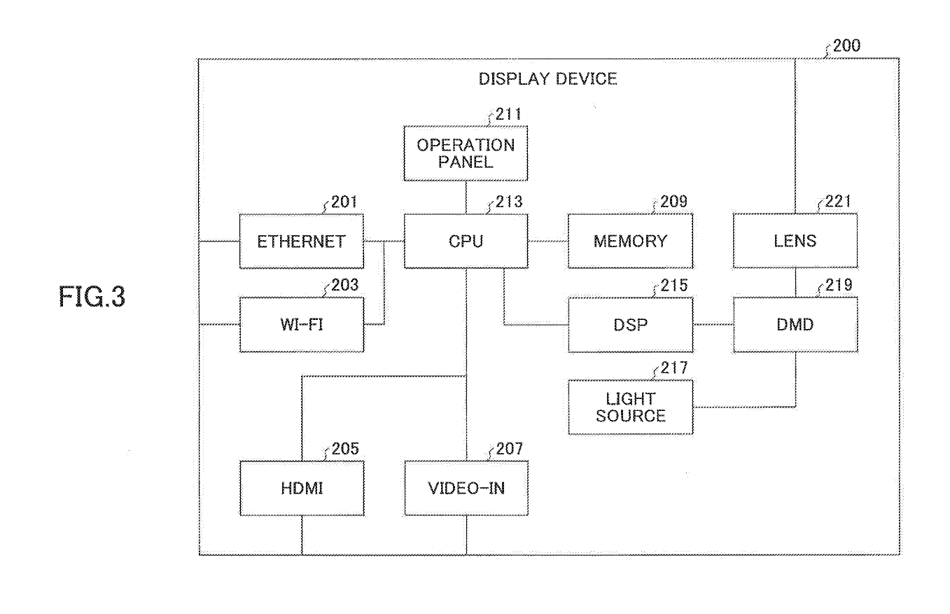

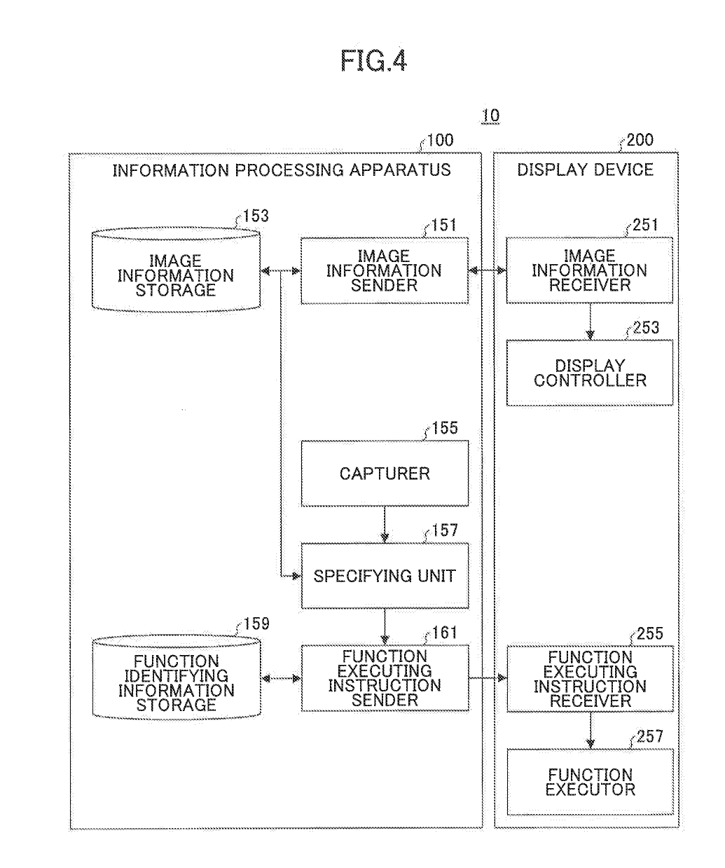

FIG. 3 is a block diagram illustrating an example of a hardware configuration of the display device 200 according to the first embodiment. As illustrated in FIG. 3, the display device 200 includes an Ethernet 201, a Wi-Fi 203, a High-Definition Multimedia Interface (HDMI) (Registered trademark; hereinafter omitted) 205, a VIDEO-IN 207, a memory 209, an operation panel 211, a CPU 213, a Digital Signal Processor (DSP) 215, a light source 217, a Digital Mirror Device (DMD) 219, and a lens 221.

The Ethernet 201 is a communication interface to a wired LAN. The Wi-Fi 203 is a communication interface to a wireless LAN. The HDMI 205 is a communication interface for transmitting a video (image) in the form of a digital signal. The VIDEO-IN 207 is a communication interface for transmitting a video (image) in the form of an analog signal.

Although, in the explanation of the first embodiment, an image (image signal) transmitted from the information processing apparatus 100 is received through the Wi-Fi 203 as an example, the method is not limited to such an example. The HDMI 205 and the VIDEO-IN 207 are used for, for example, inputting an image (image signal) of a display image 310 from an image inputting device such as a personal computer (PC) to the display device 200, so as to display the display image 310 input by the image input device by use of the display device 200. Further, the display device 200 may be able to receive an input of an image (image signal) through a USB, etc.

The memory 209 stores various types of information utilized by the CPU 213. The operation panel 211 transmits to the CPU 213 an input operation received from a user which is directed to the display device 200. The CPU 213 controls each part of the display device 200, and, upon receiving an input operation from the operation panel 211, the CPU 213 performs a process based on the input operation. The DSP 215 performs various types of image processing on an image (image signal) received through such communication interfaces as the Ethernet 201, the Wi-Fi 203, the HDMI 205, and the VIDEO-IN 207.

The light source 217 may be anything which emits light, such as a lamp. The DMD 219 reflects light emitted by the light source 217 and displays an image processed in various types of image processing performed by the DSP 215. Here, a liquid crystal panel may be employed instead of the DMD 219. The lens 221 projects light reflected by the DMD 219, so as to display (project) a display image 310 on the display 3.

FIG. 4 is a block diagram illustrating an example of a functional configuration of the information processing system 10 according to the first embodiment. As illustrated in FIG. 4, the information processing apparatus 100 includes an image information sender 151, image information storage 153, a capturer 155, a specifying unit 157, function identifying information storage 159, and a function executing instruction sender 161. Further, as illustrated in FIG. 4, the display device 200 includes an image information receiver 251, a display controller 253, a function executing instruction receiver 255, and a function executor 257.

The image information sender 151 and the function executing instruction sender 161 are embodied by, for example, the Wi-Fi 103, the memory 107, the CPU 109, etc. The image information storage 153 and the function identifying information storage 159 are embodied by, for example, the memory 107, etc. The capturer 155 is embodied by, for example, the camera 105, etc. The specifying unit 157 is embodied by, for example, the CPU 109, etc.

The image information receiver 251 and the function executing instruction receiver 255 are embodied by, for example, the Wi-Fi 203, the memory 209, the CPU 213, etc. The display controller 253 is embodied by, for example, the DSP 215, the light source 217, the DMD 219, the lens 221, etc. The function executor 257 is embodied by, for example, the memory 209, the CPU 213, etc.

The image information storage 153 stores information relating to the part-selecting image 320 having one or more display parts 330. In the first embodiment, the image information storage 153 stores part-selecting image information, which is for displaying the part-selecting image 320, and par selecting image arrangement information, which is indicative of arrangement of the one or more display parts 330 on the part-selecting image 320.

The part-selecting image information includes, but is not limited to, image data of the part-selecting image 320. The part-selecting image arrangement information includes, but is not limited to, position coordinates of the display parts 330 on the image data of the part-selecting image 320, resolution of the image data of the part-selecting image 320, etc. Although the part-selecting image information and the part-selecting image arrangement information are different information in the example taken in the explanation of the first embodiment, the part-selecting image information and the part-selecting image arrangement information may be a single set of information.

FIG. 5 is a drawing illustrating an example of the part-selecting image 320 according to the first embodiment. In an example illustrated in FIG. 5, the part-selecting image 320 includes a display part 330-1 for providing an instruction to execute A-function, a display part 330-2 for providing an instruction to execute B-function, a display part 330-3 for providing an instruction to execute C-function, a display part 330-4 for providing an instruction to execute D-function, and a display part 330-5 for providing an instruction to execute E-function, a display part 330-6 for providing an instruction to execute F-function.

Here, A- through F-functions may be any types of functions which are implemented by the display device 200, and may be, but not limited to, a function of switching input channels of an image (image signal) and a function of providing a user with an opportunity to adjust the display image 310 displayed by the display device 200.

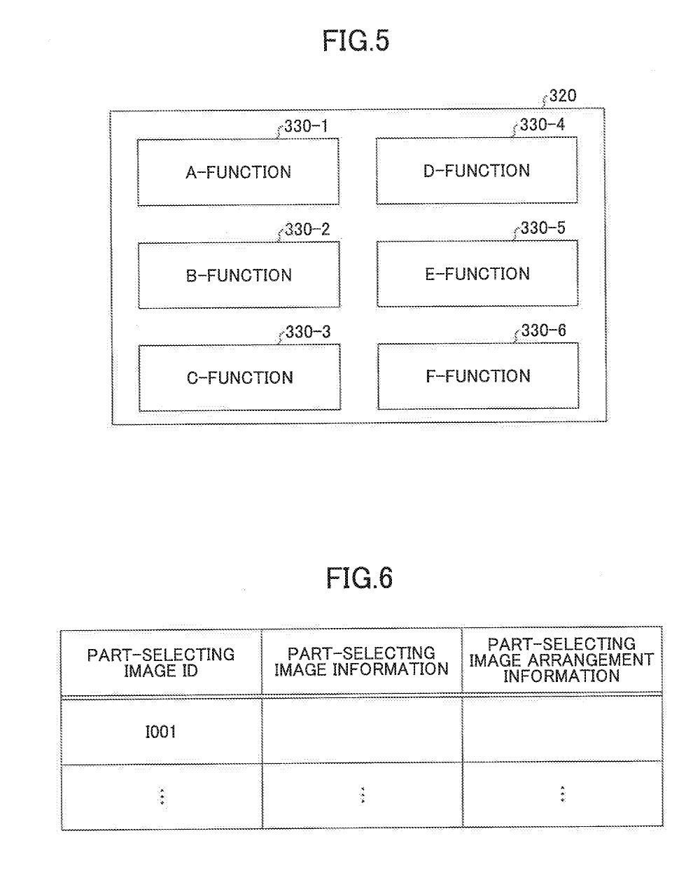

FIG. 6 is a drawing illustrating an example of information stored in the image information storage 153 according to the first embodiment. As illustrated in FIG. 6, the image information storage 153 stores part-selecting image IDs for identifying part-selecting images 320, the part-selecting image information for displaying the part-selecting images 320 identified by the respective part-selecting image IDs, and the part-selecting image arrangement information of the part-selecting images 320 identified by the respective part-selecting image IDs, in a way that the part-selecting image IDs, the part-selecting image information, and the part-selecting image arrangement information correspond to each other.

Here, in a case where a part-selecting image 320 indicated by a part-selecting image ID is the part-selecting image 320 illustrated in FIG. 5, the part-selecting image information includes image data of the part-selecting image 320 and the part-selecting image arrangement information includes position coordinates of the display parts 330-1 through 330-6 on the part-selecting image 320 and includes resolution of the image data of the part-selecting image 320. In the first embodiment, it is assumed that the position coordinates of the display parts 330 are associated with part IDs, which identify respective display parts 330, although the position coordinates of the display parts 330 are not limited to be as described here.

The position coordinates of the display parts 330-1 through 330-6 are respectively represented by, for example, two dimensional coordinates having the upper-left corner of the image data of the part-selecting image 320 as the origin. As it is assumed that the display parts 330 are rectangular in the e ample of the first embodiment, the position coordinates of the display parts 330 are represented by respective coordinates of the upper-left corners and coordinates of the lower-right corners, although the position coordinates of the display parts 330 are not limited to be as such.

The image information sender 151 sends part-selecting image information to the display device 200. For example, the image information sender 151 receives a part-selecting image ID from the display device 200, and retrieves from the image information storage part-selecting image information associated with the received part-selecting image ID, and then sends the part-selecting image information to the display device 200.

The image information receiver 251 receives part-selecting image information from the information processing apparatus 100.

The display controller 253 displays (projects) a part-selecting image 320 on the display 3, based on part-selecting image information received by the image information receiver 251. Specifically, the display controller 253 displays the display image 310 including the part-selecting image 320 on the display 3, based on the part-selecting image information received by the image information receiver 251.

In other words, the display controller 253 arranges (synthesizes) the part-selecting image 320 indicated by the part-selecting image information on the display image 310, and then displays the display image 310 including the part-selecting image 320 on the display 3. Therefore, in a case where a part-selecting image 320 indicated by part-selecting image information is the part-selecting image 320 illustrated in FIG. 5, the display image 310 including the part-selecting image 320 is displayed on the display 3, as illustrated in FIG. 1.

Then, after the display image 310 is displayed on the display 3, a user may perform an interactive operation for executing functions of the display device 200, in such a way that the user performs an instructing operation directed to the display parts 330 in the part-selecting image 320 arranged in the display image 310, by use of the instructing operation device 5.

The capturer 155 captures the display image 310 displayed on the display 3. Here, the capturer 155 captures an image where en instructing operation directed to a display part 330 is being performed by a user in the part-selecting image 320 arranged in the display image 310 displayed on the display 3, so as to capture the part-selecting image 320 displayed on the display 3, where the instructing operation device 5 is pointing at a instructing operation point. Here, in the first embodiment, it is assumed that the information processing apparatus 100 is placed at a position so that the capturing region of the capturer 155 covers the display surface of the display 3 and that the capturer 155 captures images on a regular basis, although the capturer 155 is not limited to be as such.

The specifying unit 157 specifies a display part 330 on which an instructing operation is performed, among one or more display parts 330 included in the part-selecting image 320, based on an instructing operation point on the part-selecting image 320 displayed on the display 3 by the display device 200, where an instructing operation is performed.

Specifically, the specifying unit 157 specifies a display part 330 on which an instructing operation is performed, based on a captured image obtained by the capturer 155 and part-selecting image arrangement information of the part-selecting image 320 displayed on the display 3.

More specifically, the specifying unit 157 detects coordinates of an instructing operation point, based on a captured image obtained by the capturer 155, and then specifies a display part 330 on which an instructing operation is performed, based on the detected coordinates, resolution of the captured image, resolution of a part-selecting image 320, and part-selecting image arrangement information.

For example, the specifying, unit 157 acquires part-selecting image information and part-selecting image arrangement information relating to the part-selecting image 320 displayed on the display 3 from the image information storage 153. Further, the specifying unit 157 detects coordinates of the origin (i.e. coordinates of the upper-left corner) of the part-selecting image 320 appearing on the captured image obtained by the captures and coordinates of an instructing operation point.

For example, the position of the part-selecting image 320 appearing on the captured image may be specified by use of a pattern matching method performed on the captured image and the part-selecting image information, and thereby the origin of the part-selecting image 320 may be detected. Similarly, the coordinates of an instructing operation point may be detected by way of detecting the tip of the instructing operation device appearing on the captured image. Here, the tip of the instructing operation device 5 may be detected by use of a pattern matching method, similarly to detecting the origin of the part-selecting image 320. In such a case, image data of the instructing operation device 5 may be stored in the image information storage 153.

Then, based on the coordinates of the origin of the part-selecting image 320 and the coordinates of the instructing operation point in the captured image, the specifying unit 157 calculates relative coordinates of the instructing operation point versus the origin of the part-selecting image 320, and then scales the calculated relative coordinates based on the ratio of the resolution of the part-selecting image 320 to the resolution of the captured image, in order to convert the relative coordinates to coordinates on the part-selecting image information. Here, the resolution of the captured image is acquired from the capturer 155.

As the coordinates of the instructing operation point are converted to the coordinates on the part-selecting image information in such a way, the specifying unit 157 determines whether the converted coordinates are included in any of the position coordinates of the display parts 330 obtained from the part-selecting image arrangement information, in order to specify a display part 330 (specifically an ID of the display part 330) on which an instructing operation is performed.

The method of specifying a display part 330 on which an instructing operation is performed is not limited to be as such, and, for example, a display part 330 on which an instructing operation is performed may be specified by use of a method for detecting coordinates as disclosed in Japanese Unexamined Patent Application Publication No. 2000-105671.

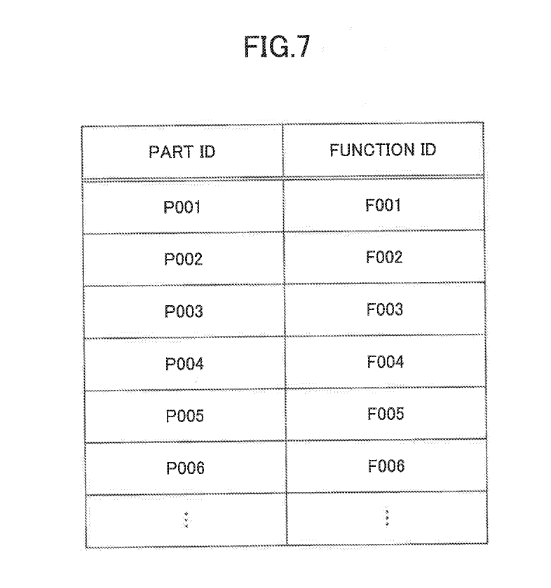

The function identifying information storage 159 stores display part specifying information which is provided for specifying display parts 330 and function specifying information which is provided for specifying functions corresponding to the respective display parts 330, in a way that the display part specifying information and the function specifying information correspond to each other. FIG. 7 is a drawing illustrating an example of information stored in the function identifying information storage 159 according to the first embodiment. In the example of FIG. 7, the function identifying information storage 159 stores part IDs provided for specifying display parts 330 and function IDs provided for specifying functions corresponding to the respective display parts 330, in a way that the part IDs and the function IDs correspond to each other.

Here, it is assumed that the part IDs P001 through P006 correspond to the display parts 330-1 through 330-6 of the part-selecting image 320 illustrated in FIG. 5, and the function IDs F001 through F006 correspond to A- through F-functions of the part-selecting image 320 illustrated in FIG. 5, respectively, although the part IDs and the function IDs are not limited to as such.

The function executing instruction sender 161 sends to the display device 200 a function executing instruction, which is an instruction to execute a function corresponding to a display part 330, where an instructing operation is performed, which is included in the part-selecting image 320 displayed on the display 3 by the display device 200.

Specifically, the function executing instruction sender 161 acquires from the function identifying information storage 159 a function ID corresponding to a part ID of a display part 330 specified by the specifying unit 157, and then sends to the display device 200 a function executing instruction, which is an instruction to execute a function corresponding to the acquired function ID. Here, the function executing instruction may be any type of information as long as the function executing instruction includes the acquired function ID.

The function executing instruction receiver 255 receives a function executing instruction from the information processing apparatus 100.

The function executor 257 executes a function based on a function executing instruction received by the function executing instruction receiver 255. For example, in a case where the function executing instruction is an instruction for executing a function of switching input channels, the function executor 257 switches input channels, and in a case where the function executing instruction is an instruction for executing a function of adjusting an image, the function executor displays an adjustment screen for a user to adjust the display image 310.

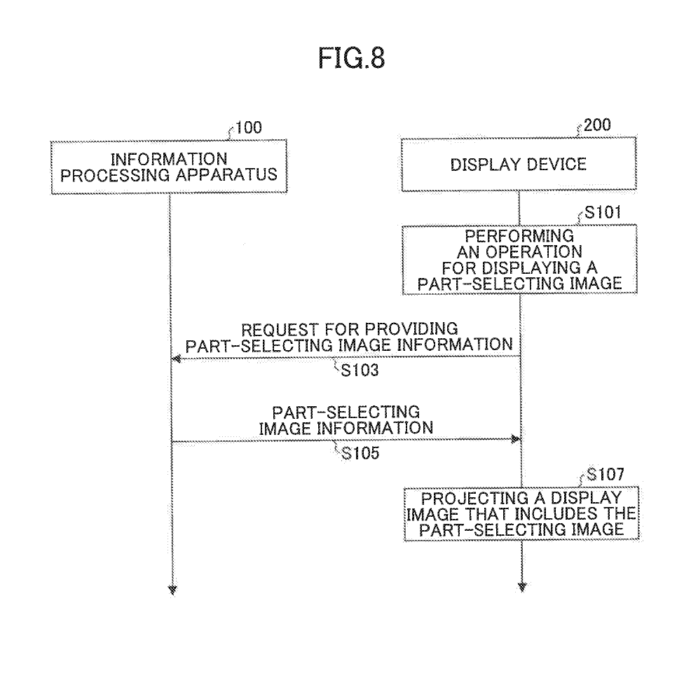

FIG. 8 is a sequence diagram illustrating an example of image projecting processing performed in the information processing system 10 according to the first embodiment.

First, when a user performs an operation for displaying a part-selecting image 320 by use of the operation panel 211 (step S101), the image information receiver 251 sends a part-selecting image ID of a default part-selecting image 320 (e.g. initial screen of the part-selecting image 320) to the information processing apparatus 100 and requests for providing part-selecting image information of the default part-selecting image 320 (step S103).

Subsequently, the image information sender 151 receives the part-selecting image ID from the display device 200 and retrieves part-selecting image information associated with the received part-selecting image ID, and then sends the retrieved part-selecting image information to the display device 200 (step S105).

Subsequently, the display controller 253 projects a display image 310 that includes the part-selecting image 320 on the display 3, based on the part-selecting image information received by the image information receiver 251 (step S107).

Here, the operation for displaying the part-selecting image 320 in step S101 may be performed by way of an interactive operation using the display image 310, instead of using the operation panel 211.

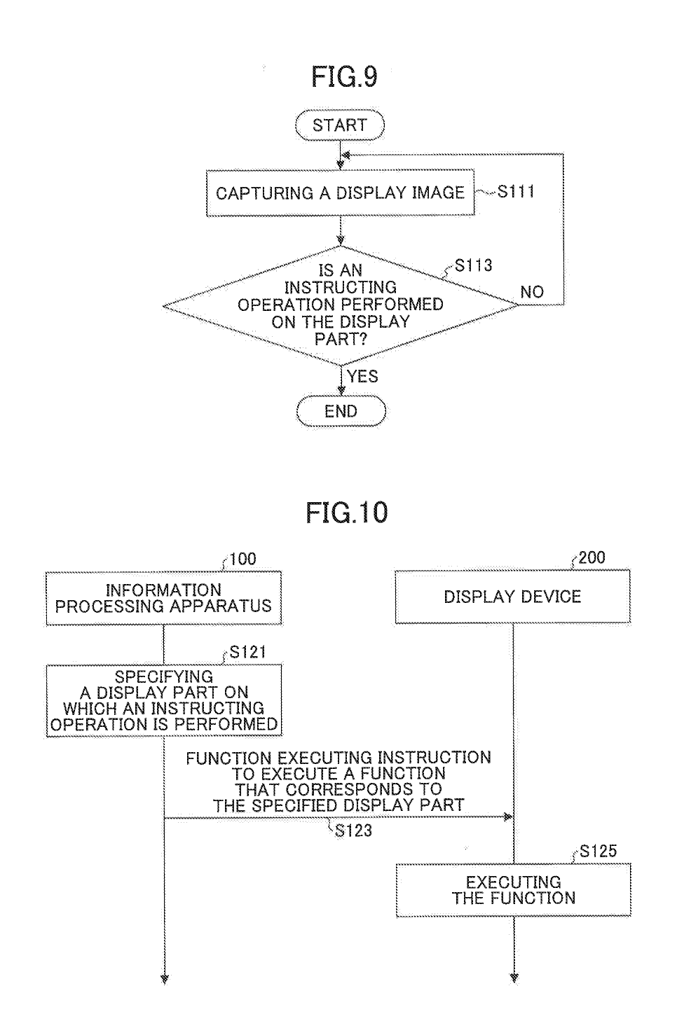

FIG. 9 is a flowchart illustrating an example of processing for confirming an instructing operation performed regularly in the information processing system 10 according to the first embodiment.

First, the capturer 155 captures a display image 310 displayed on the display 3 (step S111).

Then, the specifying unit 157 determines whether an instructing operation is performed on any of one or more display parts 330 included in a part-selecting image 320, based on an instructing operation point, where an instructing operation is performed, which is included in the part-selecting image 320 displayed on the display 3 by the display device 200 (step S113). A display part 330 on which an instructing operation is performed is specified by way of determining whether coordinates on part selecting image information corresponding to coordinates of the instructing operation point is included in sets of position coordinates of any of the display parts 330 indicated by part-selecting image arrangement information.

In a case where an instructing operation is not performed on any of the one or more display parts 330 (NO in step S113), the sequence returns to the process of step S111. In a case where an instructing operation is performed on a display part 330 (YES in step S113), the sequence proceeds to processing illustrated in FIG. 10 described below.

FIG. 10 is a sequence diagram illustrating an example of function executing processing performed in the information processing system 10 in a case where the process of step S113 in FIG. 9 is determined to be YES, according to the first embodiment.

First, the specifying unit 157 specifies a display part 330 on which an instructing operation is performed (step S121). The display part 330 on which an instructing operation is performed is specified by way of determining whether coordinates on part-selecting image information corresponding to coordinates of an instructing operation point is included in sets of position coordinates of any of the display parts 330 indicated by part-selecting image arrangement information.

Subsequently, the function executing instruction sender 161 acquires from the function identifying information storage 159 a function ID associated with a part ID of the display part 330 specified by the specifying unit 157, and sends to the display device 200 a function executing instruction to execute a function indicated by the acquired function ID. Then, the function executing instruction receiver 255 receives the function executing instruction from the information processing apparatus 100 (step S123).

Subsequently, the function executor 257 executes the function based on the function executing instruction received by the function executing instruction receiver 255 (step S125).

As described above, the method for operating the display device 200 to execute functions may be expanded because the functions of the display device 200 may be executed through an interactive operation according to the first embodiment.

Furthermore, according to the first embodiment, the information processing apparatus 100 manages part-selecting images 320 and specifies functions to be executed. (i.e. functions corresponding respective display parts where an interactive operation is performed) in addition to detecting interactive operations. Therefore, the display device 200 need not manage part-selecting images 320 or specify functions to be executed.

Such an expanded method for operating the display device 200 to execute functions may be applicable to a display device 200 on which such functions for managing part-selecting images 320 and for specifying functions to be executed are not preferably installed in consideration of the capacity of the display device 200 (e.g. a display device 200 that needs to prevent increase of a processing load of a CPU and reduction or a memory). Therefore, according to the first embodiment, the expanded method for operating the display device 200 to execute functions may be applicable to various types of display devices 200.

According to the first embodiment, it is expected that update of part-selecting images 320 may be performed more easily because the display device 200 need not manage part-selecting images 320 or specify functions to be executed.

For example, when updating a part-selecting image 320 for the purpose of changing, contracting, or expanding functions executed via an interactive operation, in case where the display device 200 manages part-selecting images 320 and specifies functions to be executed, an administrator may need to update the part-selecting images 320 managed by the display device 200, by way of, for example, updating software installed on the display device 200. Here, workload for the updating process increases as the number of the display device 200 increases. From such a viewpoint, occasionally it is not preferable that the display device 200 manages part-selecting images 320 and specifies functions to be executed.

On the other hand, in the information processing system 10 according to the first embodiment, an information processing apparatus 100 is employed for the purpose of expanding a method for operating the display device 200 for executing functions and there is no need for providing one information processing apparatus 100 per each display device 200. Here, in view of cost saving, it is expected that fewer an processing apparatuses 100 are to be employed, compared to the number of the display devices 200. Therefore, it is expected that workload for updating managed part-selecting images 320 by way of updating software, etc., becomes smaller, compared to a case where the display devices 200 manage part-selecting images 320 and specify functions to be executed. In such a way, expansion of a method for operating display devices 200 to execute functions is applicable to various types of display devices 200.

### Second Embodiment

In the second embodiment, an example of part-selecting images 1320 and 1321 corresponding to types of the display devices 200 will be explained. In the following, elements that are different from the first embodiment will be mainly explained, whereas elements that have functions similar to the functions described in the first embodiment will be assigned with names and reference signs which are the same as in the first embodiment so as to omit duplicate explanations.

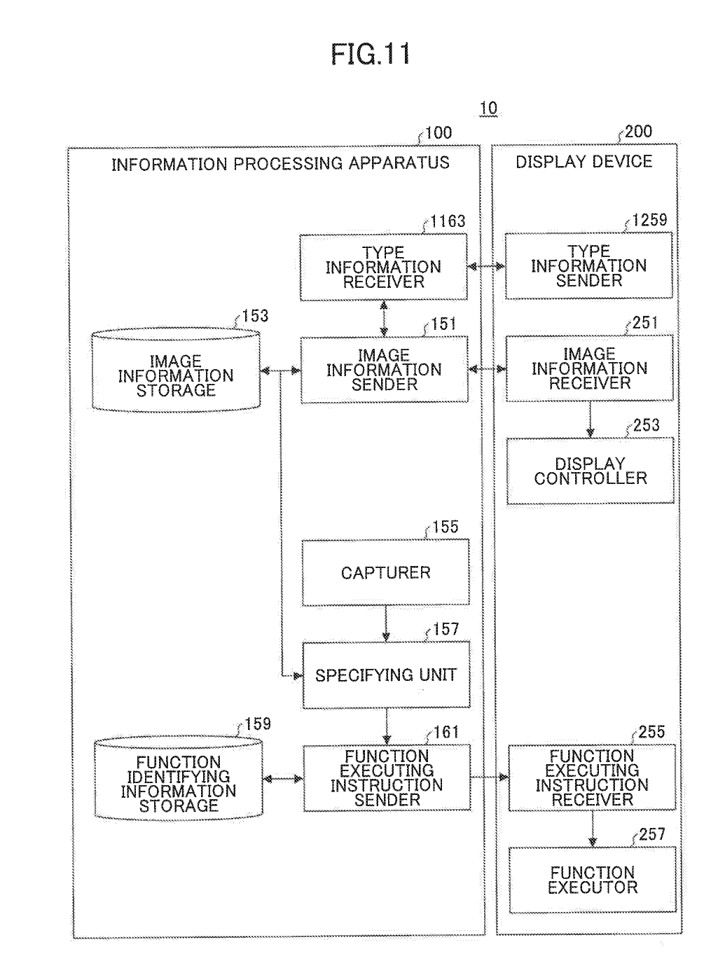

FIG. 11 is a block diagram illustrating an example of a functional configuration of the information processing system 10 according to the second embodiment. As illustrated in FIG. 11, the second embodiment and the first embodiment are different in terms of the image information sender 151, the image information storage 153, and a type information receiver 1163 provided in the information processing apparatus 100 and a type information sender 1259 provided in the display device 200.

The type information sender 1259 sends type information, which indicates a type of the display device 200, to the information processing apparatus 100. The type of the display device 200 is, for example, a model name, etc., although the type is not limited to as such. Here, the type information is preliminarily stored, for example, in the memory 209, etc.

The type information receiver 1163 receives type information from the display device 200.

According to the second embodiment, the image information storage 153 further stores type information, which indicates a type of the display device 200. Here, in the second embodiment, the part-selecting images 1320 and 1321 include some or all of the display parts 1330-1 through 1330-6 depending on types indicated by type information. In other words, in the second embodiment, display parts 1330-1 through 1330-6 included in the part-selecting images 1320 and 1321 are different, depending on types of the display devices 200.

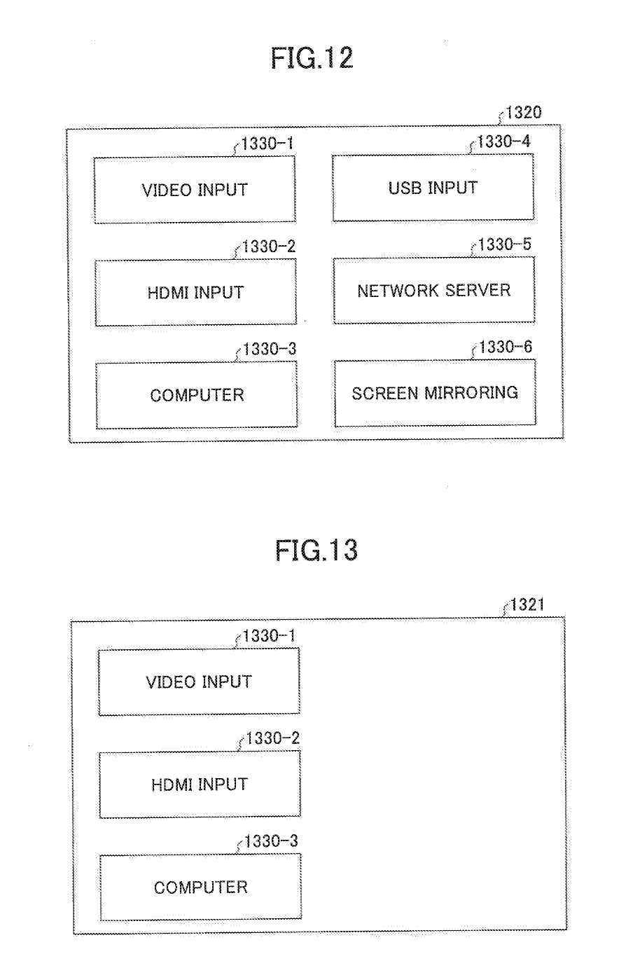

FIG. 12 and FIG. 13 are drawings illustrating examples of the part-selecting images 1320 and 1321 according to the second embodiment. In FIG. 12, an example of the part-selecting image 1320 in a case where the display device 200 is a multi-function model is illustrated, whereas in the FIG. 13, an example of the part-selecting image 1321 in a case where the display device 200 is a limited-function model is illustrated. Here, the part-selecting images 1320 and 1321 illustrated in FIG. 12 and FIG. 13 respectively include display parts 1330-1 through 1330-6 for providing an instruction for executing a function to switch input channels of an image (image signal).

In the example illustrated in FIG. 12, a part-selecting image 1320 includes a display part 1330-1 for providing an instruction to execute a function of switching input channels to a VIDEO INPUT, a display part 1330-2 for providing an instruction to execute a function, of switching input channels to a HDMI INPUT, a display part 1330-3 for providing an instruction to execute a function of switching input channels to a COMPUTER, a display part 1330-4 for providing an instruction to execute a function of switching input channels to a USB INPUT, a display part 1330-5 for providing an instruction to execute a function of switching input channels to a NETWORK SERVER, and a display part 1330-6 for providing an instruction to execute a function of switching input channels to a SCREEN MIRRORING.

On the other hand, in the example illustrated in FIG. 13, the part-selecting image 1321 includes the display part 1330-1 for providing the instruction to execute the function of switching input channels to the VIDEO INPUT, the display part 1330-2 for providing the instruction to execute t e function of switching input channels to the HDMI INPUT, and the display part 1330-3 for providing the instruction to execute the function of switching input channels to the COMPUTER.

In such a way, the display parts 1330-1 through 1330-6 included in the part-selecting images 1320 and 1321 are different because the multi-function model has a large variety of input channels and the limited-function model has a limited variety of input channels. In other words, the display parts 1331-1 through 1330-6 included in the part-selecting images 1320 and 1321 are different because executable functions are different depending on models of the display devices 200.

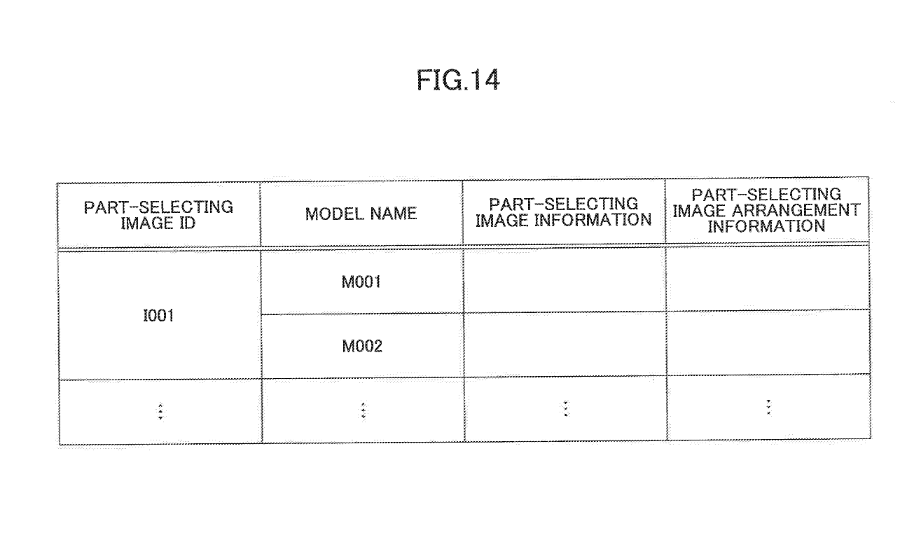

FIG. 14 is a drawing illustrating an example of information stored in the image information storage 153 according to the second embodiment. In the example of FIG. 14, the image information storage 153 stores model names that indicate types of the display devices 200 in a way that the model names are associated with part-selecting image IDs, and stores part-selecting image information and part-selecting image arrangement information of the part-selecting images 1320 and 1321 in a way that the part-selecting image information and the part-selecting image arrangement information are associated with the model names.

The image information sender 151 sends part-selecting image information corresponding to type information received by the type information receiver 1163 to the display device 200. For example, the image information sender 151 acquires, from the image information storage 153, part-selecting image Information corresponding to a part-selecting image ID received from the display device 200 and a model name received by the type information receiver 1163, and then sends the part-selecting image information to the display device 200.

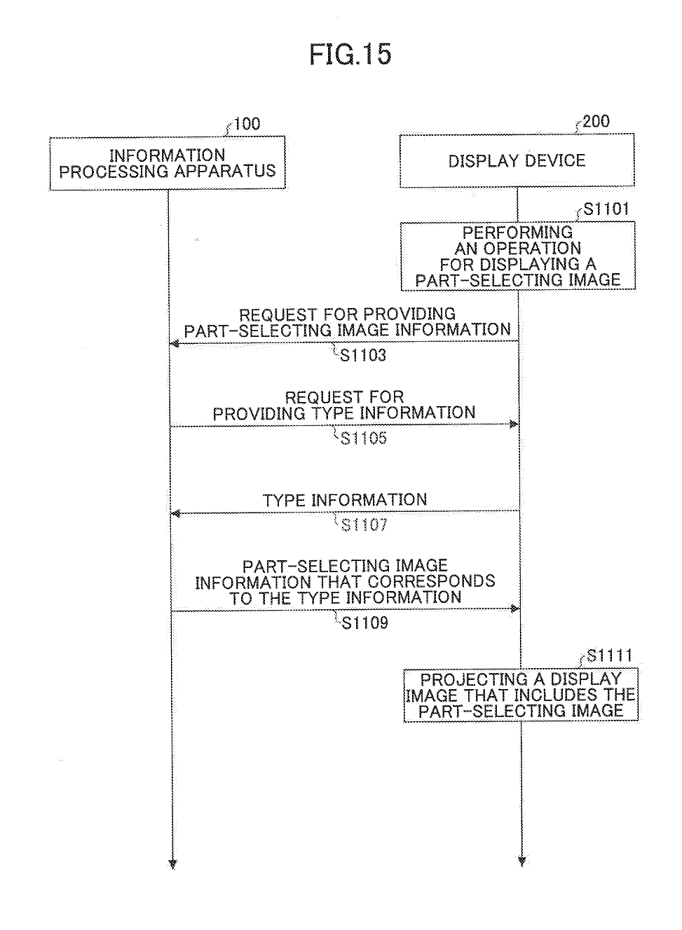

FIG. 15 is a sequence diagram illustrating an example of image projecting processing performed in the information processing system 10 according to the second embodiment.

First, processes of steps S1101 and S1103 are the same as steps S101 and S103 in the sequence diagram in FIG. 8.

Subsequently, after the information processing apparatus 100 receives a request for providing part-selecting image information of a default part-selecting image 1320 or 1321, the type information receiver 1163 requests the display device 200 to provide type information (step S1105).

Then, after the type information sender 1259 receive the request for providing the information from the information processing apparatus 100, the display device 200 sends the type information to the information processing apparatus 100, the type information receiver 1163 receives the type information from the display device 200 (step S1107).

Then, the image information sender 151 acquires, from the image information storage 153, part-selecting image information corresponding to the part-selecting image ID received from the display device 200 and the type information (i.e. model name) received by the type information receiver 1163, and then sends the part-selecting image information to the display device 200 (step S1109).

The following process of step S1111 is the same as the step S107 in the sequence diagram in FIG. 8.

As described above, according to the second embodiment, expansion of an operation method for executing functions of the display device 200 is applicable to various models of the display devices 200. Especially, according to the second embodiment, it is expected that fewer information processing apparatuses 100 may be employed compared to the number of the display devices 200, as there is no need for providing one information processing apparatus 100 per each model of the display devices 200. Therefore, it is expected that workload for updating managed part-selecting images 1320 and 1321 by way of updating software, etc., becomes smaller than a case where each of the display devices 200 manage part-selecting images 1320 and 1321 and specify functions to be executed. In such a way, expansion of an operation method for executing functions of the display device 200 is applicable to various models of the display device 200.

Here, the function identifying information storage 159 may store display part identifying information and function identifying information, in a way that the display part identifying information and the function identifying information correspond to respective types indicated by type information. In such a case, the function identifying information storage 159 stores table information associating the respective types indicated by the type information with the display part identifying information for identifying each of the display parts 1330-1 through 1330-6 for providing an instruction to execute a function and the function identifying information for identifying each of the functions executable by use of the respective types of display devices 200. Here, the function executing instruction sender 161 acquires, from the function identifying information storage 159, function identifying information that corresponds to display part identifying information associated with one of the display parts 1330-1 through 1330-6 specified by the detector 157, referring to the table information based on the respective types of the display devices 200.

### Third Embodiment

In the third embodiment, an example of part-selecting images 2320 and 2321 that correspond to modes of the display device 200 will be explained. In the following, elements that are different from the first embodiment will be mainly explained, whereas elements that have functions similar to the functions described in the first embodiment will be assigned with names and reference signs which are the same as in the first embodiment so as to omit duplicate explanations.

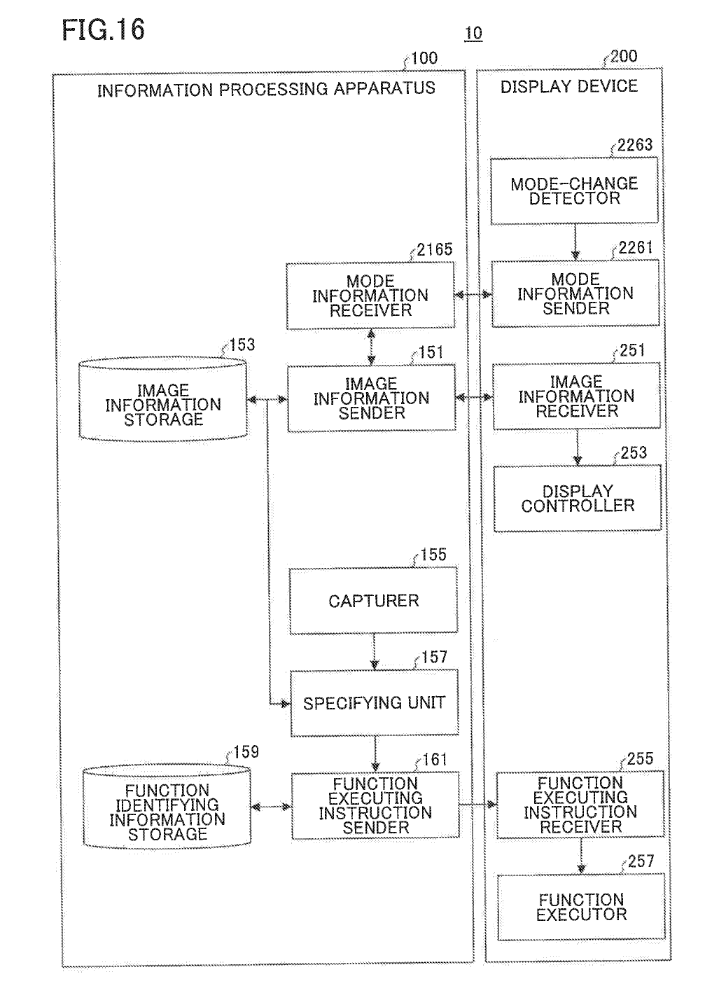

FIG. 16 is a block diagram illustrating an example of a functional configuration of the information processing system 10 according to the third embodiment. As illustrated in the FIG. 16, the third embodiment and the first embodiment are different in terms of the image information sender 151, the image information storage 153, and a mode information receiver 2165 provided in the information processing apparatus 100 and a mode information sender 2261 and a mode-change detector 2263 provided in the display device 200.

The mode-change detector 2263 detects a change of modes of the display device 200. The mode of the display device 200 may be, but is not limited to, a regular mode and an energy-saving mode, energy-saving mode is a mode that consumes a smaller amount of energy compared to the regular mode. Here a change of the modes of the display device 200 may be performed, for example, by a user through the operation panel 211 or may be performed automatically.

Examples of an automatic mode-change are, for example, changing the modes from the regular mode to the energy-saving mode in the absence of an input of an image (i.e. image signal) and a user operation for a predetermined period of time, and changing the modes from the energy-saving mode to the regular mode responding to an input of an image (i.e. image signal) and a user operation, although the automatic mode-change is not limited to as such. Here, the display device 200 stores the mode of the display device 200 as mode information, for example, in the memory 209, etc. The mode change detector 2263 detects a change of the modes of the display device 200 by way of detecting a change of the modes indicated by the mode information stored in the memory 209.

The mode information sender 2261 sends mode information of the display device 200 to the information processing apparatus 100. The mode information receiver 2165 receives the mode information from the display device 200.

According to the third embodiment, the image information storage 153 further stores mode information that indicates mode of the display device 200. Here, in the third embodiment, part-selecting images 2320 and 2321 include one or more display parts 2330-1 through 2330-6 corresponding to the modes indicated by the mode information. In other words, in the third embodiment, one or more display parts 2330-1 through 2330-6 included in the part-selecting image 2320 and 2321 are different depending on the modes of the display device 200.

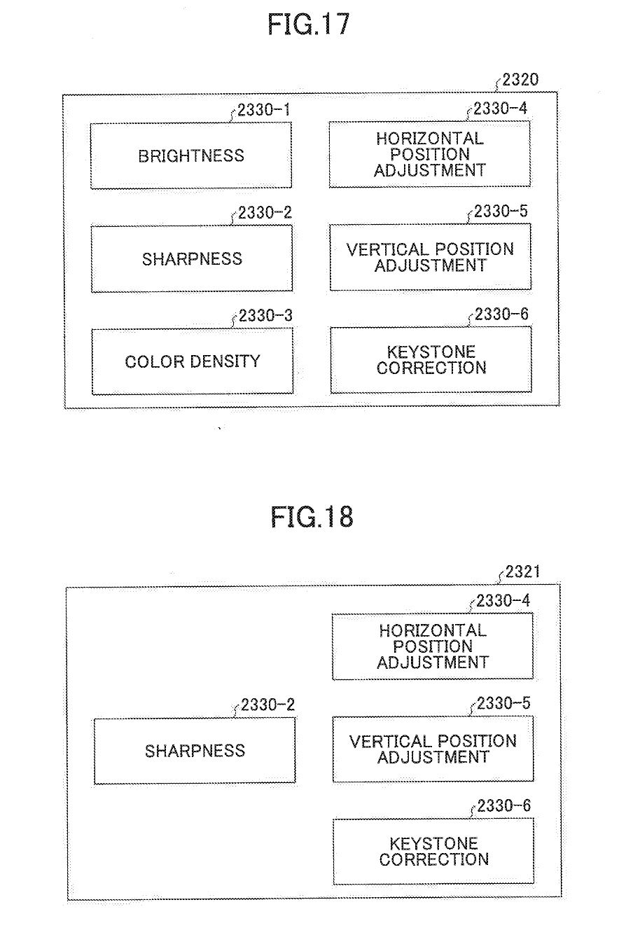

FIG. 17 and FIG. 18 are drawings illustrating examples of the part-selecting images 2320 and 2321 according to the third embodiment. In FIG. 17, an example of the part-selecting image 2320 in a case where the display device 200 is on a regular mode is illustrated, whereas in the FIG. 18, an example of the part-selecting image 2321 in a case where the display device 200 is on an energy-saving mode is illustrated. Here, the part-selecting images 2320 and 2321 illustrated in FIG. 17 and FIG. 18 respectively include display parts 2330-1 through 2330-6 for executing functions of adjusting the display image 310.

In the example illustrated in FIG. 17, the part-selecting image 2320 includes the display part 2330-1 for providing an instruction to execute a function of adjusting brightness of the display image 310, the display part 2330-2 for providing an instruction to execute a function of adjusting sharpness of the display image 310, the display part 2330-3 for providing an instruction to execute a function of adjusting color density of the display image 310, the display part 2330-4 for providing an instruction to execute a function of adjusting a horizontal position of the display image 310, the display part 2330-5 for providing an instruction to execute a function of adjusting a vertical position of the display image 310, and the display part 2330-6 for providing an instruction to execute a function of performing a keystone correction of the display image 310.

On the other hand, in the example illustrated in FIG. 18, the part-selecting image 2321 includes the display part 2330-2 for providing the instruction to execute the function of adjusting the sharpness of the display image 310, the display part 2330-4 for providing the instruction to execute the function of adjusting the horizontal position of the display image 310, the display part 2330-5 for providing the instruction to execute the function of adjusting the vertical position of the display image 310, and the display part 2330-6 for providing the instruction to execute the function of performing the keystone correction of the display image 310.

In such a way, the one or more display parts 2330-1 through 2330-6 included in the part-selecting images 2320 and 2321 are different because a large variety of adjustments of the display image 310 may be performed in the regular mode whereas only a limited variety of adjustments of the display image 310, excluding adjustments that may not be performed due to a matter of energy consumption such as the adjustments of brightness and color density, may be performed in the energy-saving mode in order to reduce energy consumption. In other words, according to the third embodiment, one or more display parts 2330-1 through 2330-6 included in the part-selecting images 2320 and 2321 are different because executable functions are different depending on modes of the display device 200.

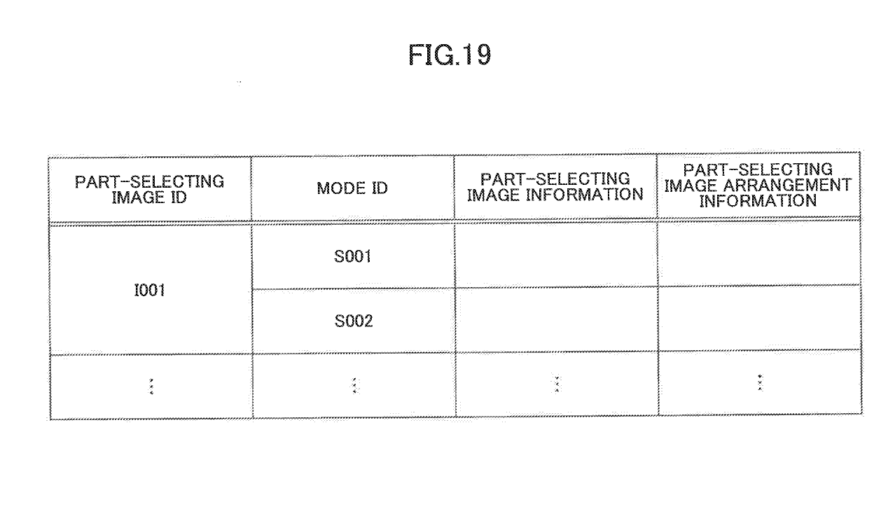

FIG. 19 is a drawing illustrating an example of information stored in the image information storage 153 according to the third embodiment. In the example of FIG. 19, the image information storage 153 stores mode IDs that indicate modes of the display devices 200 in a way that the mode IDs correspond to respective part-selecting image IDs, and stores part-selecting image information and part-selecting image arrangement information of the part-selecting images 2320 and 2321 that are specified by the respective mode IDs and the part-selecting image IDs corresponding to the respective mode IDs in a way that the stores part-selecting image information and the part-selecting image arrangement information correspond to the respective mode IDs.

The image information sender 151 sends part-selecting image information that corresponds to mode information received by the mode information receiver 2165 to the display device 200. For example, the image information sender 151 acquires, from the image information storage 153, part-selecting image information that corresponds to a part-selecting image ID received from the display device 200 and a mode ID received by the mode information receiver 2165, and then sends the acquired part-selecting image information to the display device 200.

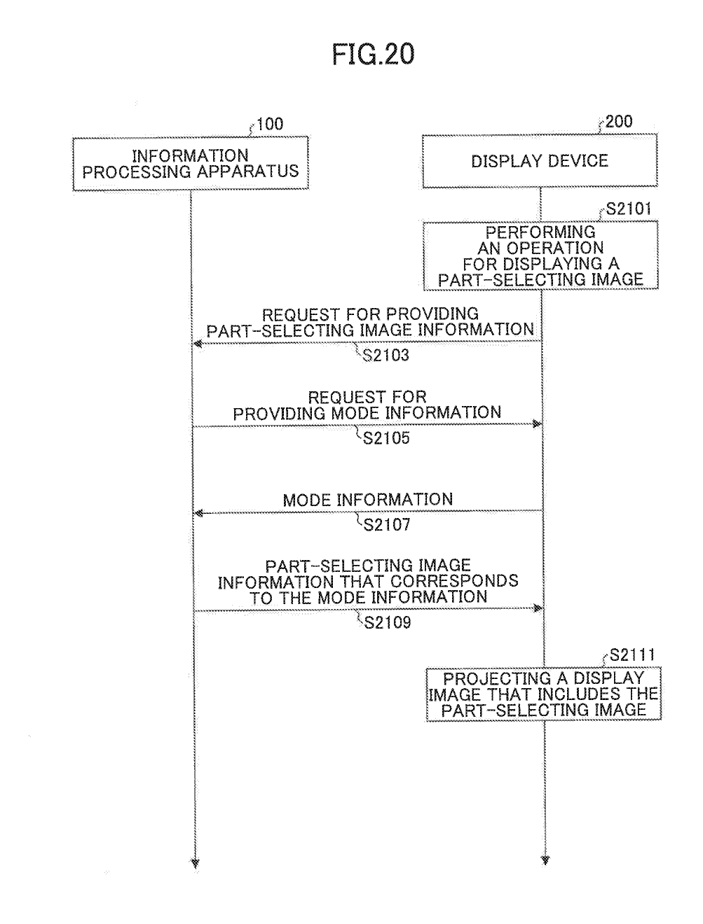

FIG. 20 is a sequence diagram illustrating an example of image projecting processing performed in the information processing system 10 according to the third embodiment.

First, processes of steps S2101 and S2103 are the same as the processes of steps S101 and S103 in the sequence diagram illustrated in FIG. 8, respectively.

Subsequently, after the information processing apparatus 100 receives a request for providing part-selecting image information of a default part-selecting image 2320 or 2321, the mode information receiver 2165 requests the display device 200 for providing mode information (step S2105).

Then, upon receiving from the information processing apparatus 100 the request for providing the mode information, the mode information sender 2261 sends mode information of the display device 200 to the information processing apparatus 100, and then the mode information receiver 2165 receives the mode information from the display device 200 (step S2107).

Then, the image information sender 151 acquires, from the image information storage 153, the part-selecting image information that corresponds to a part-selecting image ID received from the display device 200 and the mode information (i.e. mode ID) received by the mode information receiver 2165, and then sends the part-selecting image information to the display device 200 (step S2109).

A following process of step S2111 is the same as the process of step 2107 in the sequence diagram illustrated in FIG. 8.

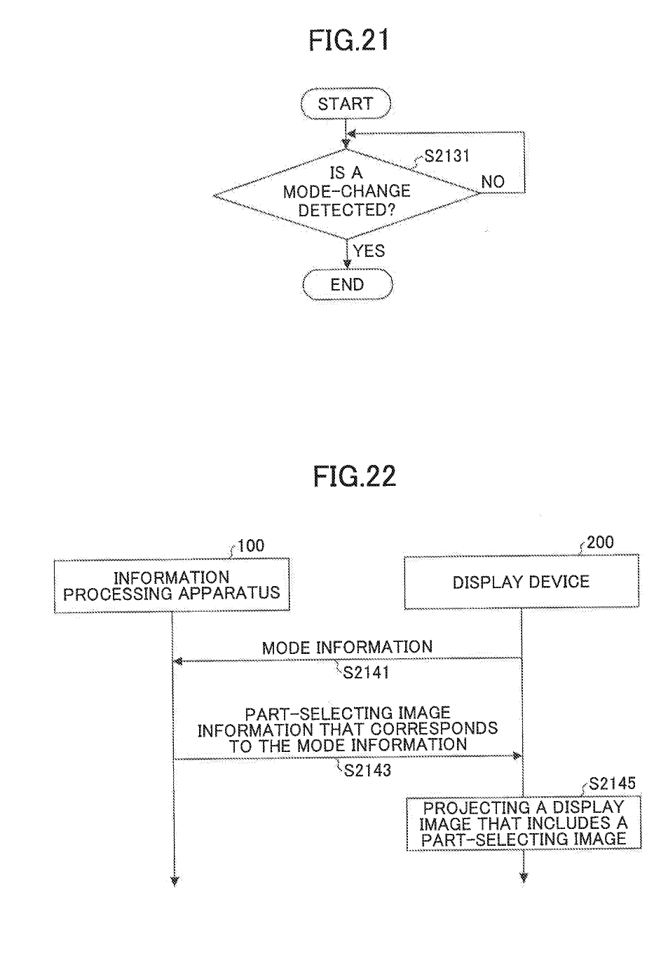

FIG. 21 is a flowchart illustrating an example of mode-change detecting processing performed regularly in the display device 200 according to the third embodiment.

In a case where a change of modes of the display device 200 is not detected by the mode-change detector 2263 (NO in step S2131), the sequence returns to step S2131. On the other hand, in a case where a change of the modes of the display device 200 is detected by the mode-change detector 2263 (YES in step S2131), the sequence proceeds to a later described process illustrated in FIG. 22.

FIG. 22 is a sequence diagram illustrating an example of image projecting processing performed in the information processing system 10 of the third embodiment, in a case where mode of the display device 200 is changed.

First, the mode information sender 2261 sends mode information of the display device 200 to the information processing apparatus 100, and then the mode information receiver 2165 receives the mode information from the display device 200 (step S2141),

Following processes of steps S2143 and S2145 are the same as the processes of steps S2109 and S2111 in the sequence diagram illustrated in FIG. 20.

As described above, according to the third embodiment, the method for operating the display device 200 to execute a function may be expanded, in consideration of a variety modes of the display device 200.

Here, the function identifying information storage 159 may store display part identifying information and function identifying information, in a way that the display part identifying information and the function identifying information, corresponding to each other, are association with respective modes indicated by mode information. In such a case, the function identifying information storage 159 stores table information, which associates the respective modes indicated by the mode information with the function identifying information of functions executable in respective modes of the display device 200 and the display part identifying information of display parts 2330-1 through 2330-6 for providing instructions to execute the functions. Further, the function executing instruction sender 161 acquires, from the function identifying information storage 159, function identifying information corresponding to display part identifying information of one of the display parts 2330-1 through 2330-6 that is specified by the specifying unit 157, referring to the table information corresponding to modes of the display device 200.

### Fourth Embodiment

In the fourth embodiment,an example of updating display content of the part-selecting image 3320 upon executing a function will be explained. In the following, elements that are different from the first embodiment will be mainly explained, whereas elements that have functions similar to the functions described in the first embodiment will be assigned with names and reference signs which are the same as in the first embodiment so as to omit duplicate explanations.

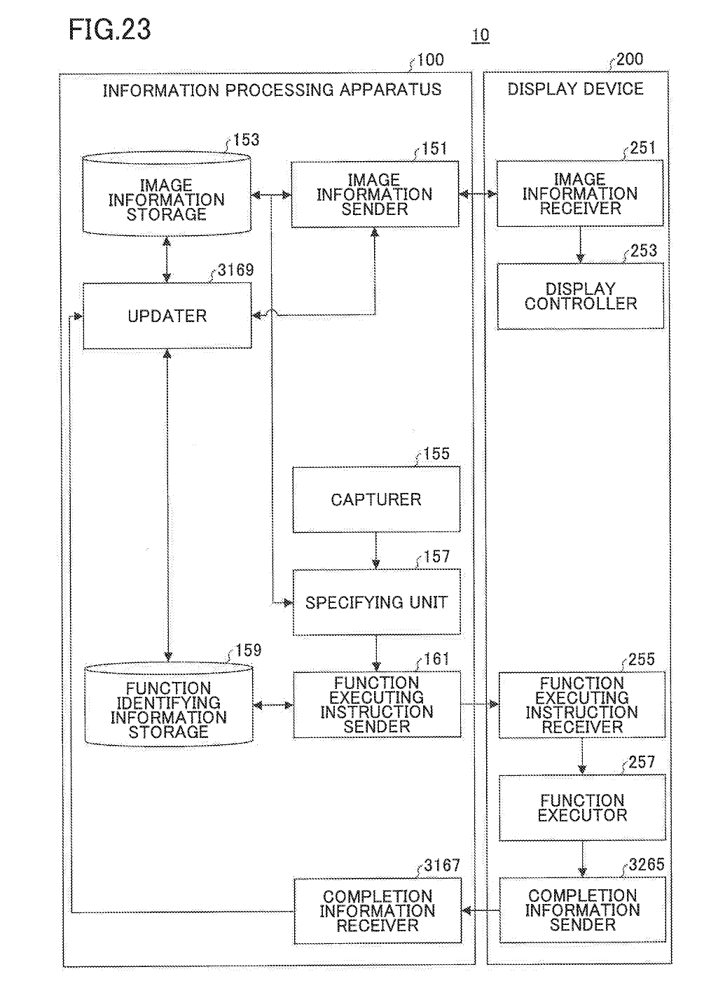

FIG. 23 is a block diagram illustrating an example of a functional configuration of the information processing system 10 according to the fourth embodiment. As illustrated in FIG. 23, the fourth embodiment and the first embodiment are different, in terms of the image information sender 151, a completion information receiver 3167, and an updater 3169 of the information processing apparatus 100 and the image information receiver 251, the display controller 253, and a completion information sender 3265.

The completion information sender 3265 sends to the information processing apparatus 100 completion information, which indicates that an execution of a function in accordance with a function executing instruction is completed. Here, the completion information may be any type of information as long as the completion information includes function identifying information (i.e. function ID) that specifies an executed function.

The completion information receiver 3167 receives completion information from the display device 200.

The updater 3169 updates part-selecting image information of the part-selecting image 3320 based on completion information received by the completion information receiver 3167, so that display content of the part-selecting image 3320 displayed on the display 3 is updated.

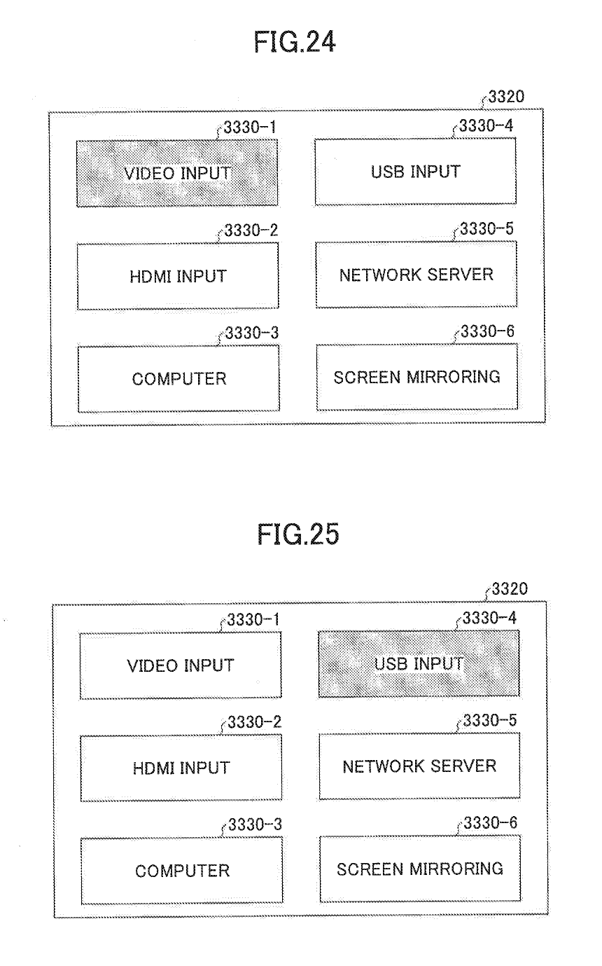

Here is an example in a case where a part-selecting image 3320 included in a display image 310 before a function is executed by the function executor 257 is the part-selecting image 3320 illustrated in FIG. 24. Here, in the part-selecting image 3320, it is indicated that the input channel is VIDEO-INPUT in the way that the display part 3330-1 is highlighted. Here, it is presumed that a function of switching the input channels from VIDEO-INPUT to USB-INPUT is executed by the function executor 257 and the completion information receiver 3167 receives, from the display device 200, completion information including a function ID of the function of switching the input channels to USE-INPUT.

In such a case, the updater 3169 acquires, from the image information sender 151, a part-selecting image ID of part-selecting image information lastly sent from the image information sender 151, and then acquires, from the image information storage 153, the part-selecting image information and part-selecting image arrangement information corresponding to the part-selecting image ID. Further, the updater 3169 acquires, from the function identifying information storage 159, a part ID corresponding to a function ID included in completion information. Then, the updater 3169 updates the part-selecting image information in the way of highlighting a position obtained from the part-selecting image information of one of the display parts 3330-1 through 3330-6 specified by the acquired part ID, referring to the acquired part selecting image arrangement information.

The image information sender 151 sends part-selecting image information updated by the updater 3169 to the display device 200. The image information receiver 251 receives the updated part-selecting image information from the information processing apparatus 100.

The display controller 253 displays an updated part-selecting image 3320 based on part-selecting image information updated by the updater 3169. Here, the above-described image processing is performed on the part-selecting image 3320 included, in the display image 310 displayed on the display 3, and therefore it is indicated that the input channel is USB INPUT in the way that the display part 3330-4 is highlighted as illustrated in FIG. 25.

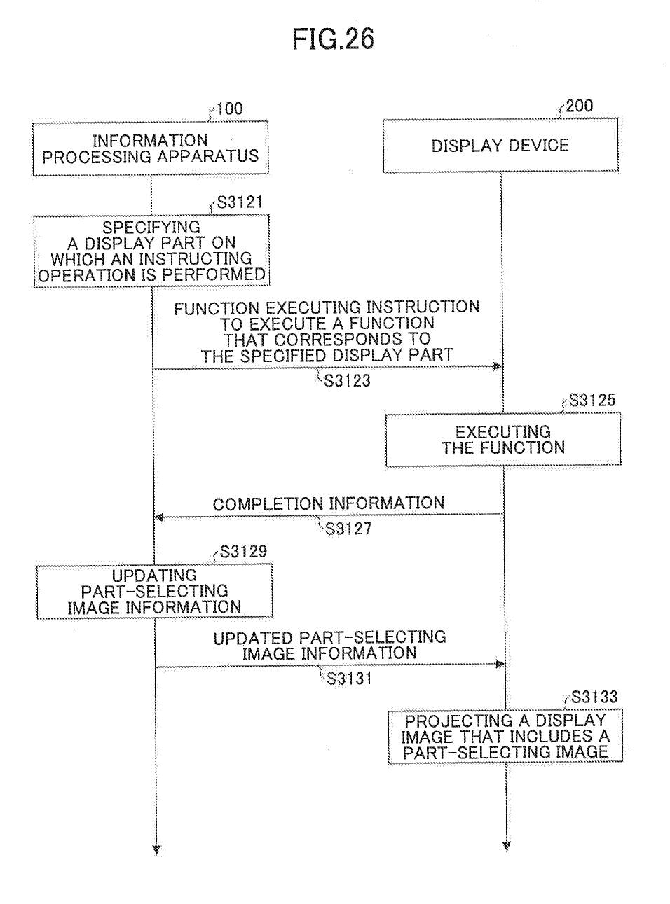

FIG. 26 is a sequence diagram illustrating an example of function executing processing performed in the information processing system 10 according to the fourth embodiment.

First, processes of steps S3121 through S3125 are the same as the processes of steps S121 through S125 illustrated in the sequence diagram of FIG. 10.

Subsequently, the completion information sender 3265 sends, to the information processing apparatus 100, completion information which indicates that an execution of a function completed in accordance with a function executing instruction, and then the completion information receiver 3167 receives the completion information from the display device 200 (step S3127).

Then, the updater 3169 updates part-selecting image information of a part-selecting image 3320 based on the completion information received by the completion information receiver 3167, so that display content of the part-selecting image 3320 displayed on the display 3 is updated (step S3129).

Then, the image information sender 151 sends the part-selecting image information updated by the updater 3169 to the display device 200, and then the image information receiver 251 receives the updated part-selecting image information from the information processing apparatus 100 (step S3131).

Then, the display controller 253 projects an updated part-selecting image 3320 on the display 3, based on the part-selecting image information received by the image information receiver 251 (step S3133).

As described above, according to the fourth embodiment, a result of an execution of a function may be reported to a user.

### Fifth Embodiment

In the fifth embodiment, an example of magnifying a part-selecting image 4320 displayed on the display 3 will be explained. In the following, elements that are different from the first embodiment will be mainly explained, whereas elements that have functions similar to the functions described in the first embodiment will be assigned with names and reference signs which are the same as in the first embodiment so as to omit duplicate explanations.

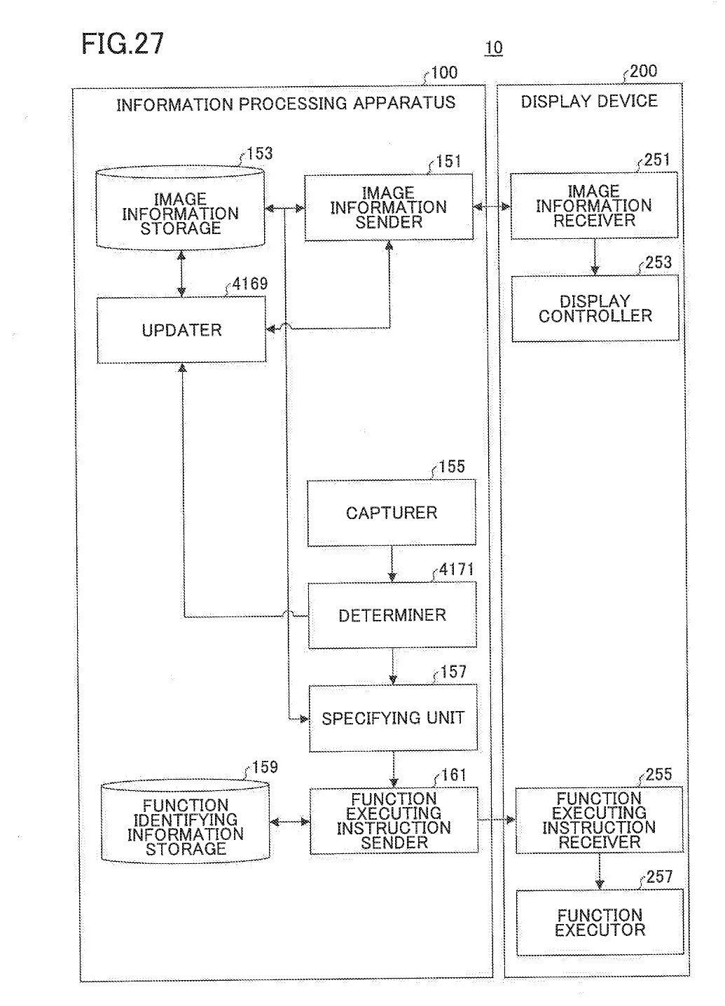

FIG. 27 is a block diagram illustrating an example of a functional configuration of the information processing system 10 according to the fifth embodiment. As illustrated in FIG. 27, the fifth embodiment and the first embodiment are different in terms of the image information sender 151, a determiner 4171, and an updater 4159 provided in the information processing apparatus 100 and the image information receiver 251 and the display controller 253 provided in the display device 200.

The determiner 4171 determines whether the size of the part-selecting image 4320 appearing on a captured image obtained by the capturer 155 meets a predetermined condition. According to the fifth embodiment, the determiner 4171 determines whether the size of the part-selecting image 4320 appearing on the captured image obtained by the capturer 155 is smaller than a predetermined threshold.

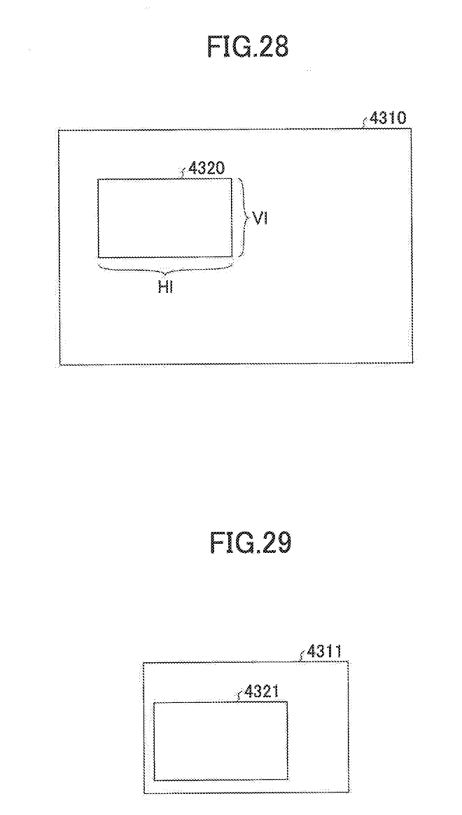

In the fifth embodiment, the determiner 4171 determines whether a vertical length Vl of the part-selecting image 4320 included in a display image 4310 appearing on the captured image is smaller than a threshold value TVl (i.e. Vl<TVl) as illustrated in FIG. 28, although the determiner 4171 is not limited to be as such and the determiner 4171 may, for example, determine whether a horizontal length Hl of the part-selecting image 4320 is smaller than a threshold value or determine whether an area of the part-selecting image 4320 is smaller than a threshold value.

In a case where the size of the part-selecting image 4320 is determined not to meet a predetermined condition by the determiner 4171, the updater 4169 updates part-selecting image information of the part-selecting image 4320 so as to change the size of the part-selecting image 4320 displayed on the display 3. Specifically, in a case where the size of the part-selecting image 4320 is smaller than a threshold value, the updater 4169 updates the part-selecting image information of the part-selecting image 4320 so as to magnify the size of the part-selecting image 4320 displayed on the display 3.

According to the fifth embodiment, the updater 4169 acquires part-selecting image ID of part-selecting image information lastly sent from the image information sender 151, and then acquires part-selecting image information and part-selecting image arrangement information corresponding to the part selecting image ID from the image information storage 153. Then, in a case where resolution of the vertical length of the part-selecting image information is Vd and the horizontal length of the part-selecting image information is Hd, the updater 4169 updates the part-selecting image information, in the way of magnifying the resolution Vd of the vertical length and the resolution Rd of the horizontal length in the rate of TVl/Vl, respectively.

The image information sender 151 sends the part-selecting image information updated by the updater 4169 to the display device 200. The image information receiver 251 receives the updated part-selecting image information from the information processing apparatus 100.

The display controller 253 displays a scaled part-selecting image 4321 on the display 3, based on the part-selecting image information updated by the updater 4169. Specifically, the display controller 253 the magnified part-selecting image 4321 on the display 3, based on the part-selecting image information updated by the updater 4169. In such a case, as the above-described magnification processing is performed on the part-selecting image 4320 included in the display image 4310 displayed on the display 3, the proportion of a part-selecting image 4321 to a display image 4311 is bigger as illustrated in FIG. 29.

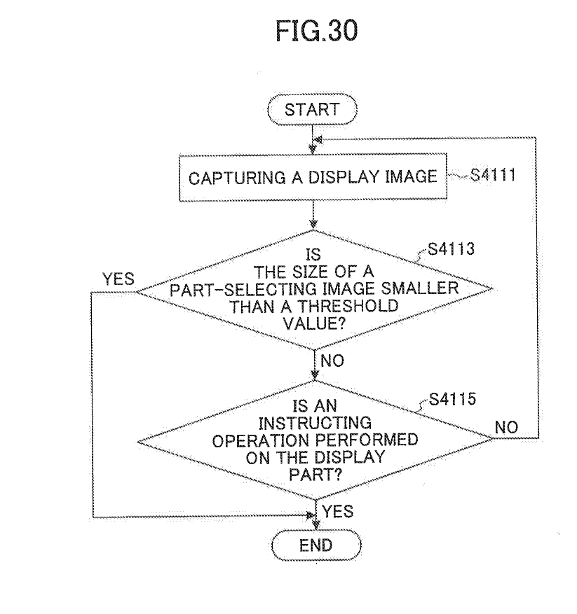

FIG. 30 is a flowchart illustrating an example of processing for confirming an instructing operation performed in the information processing system 10 according to the fifth embodiment.

First, a process of step S4111 is the same as the step S111 in the flowchart illustrated in FIG. 9.

Subsequently, the determiner 4171 determines whether the size of the part-selecting image 4320 appearing on a captured image obtained by the capturer 155 is smaller than a threshold value (step S4113).

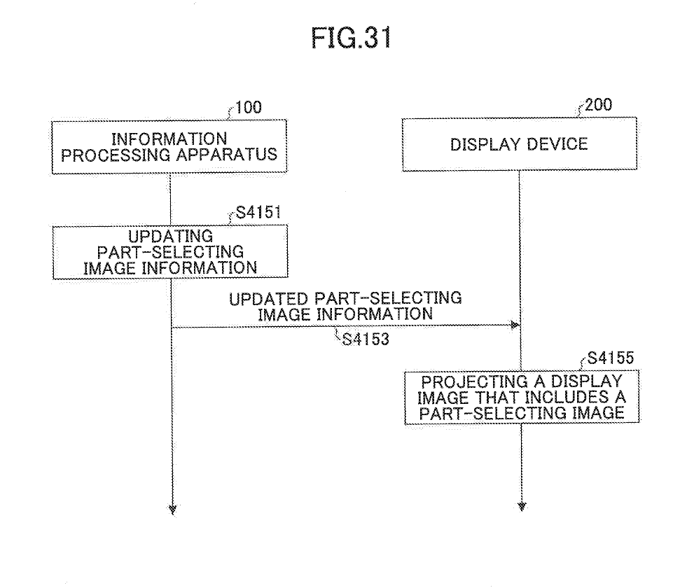

In a case where the size of the part-selecting image 4320 is smaller than the threshold value (YES in step S4113), the sequence proceeds to processing illustrated in FIG. 31. On the other hand, in a case where the size of the part-selecting image 4320 is bigger than the threshold value (NO in step S1113), the sequence proceeds to step S4155.

A following process described as step S4115 is the same as the process of step S113 in the flowchart illustrated in FIG. 9.

FIG. 31 is a sequence diagram illustrating an example of image projecting processing performed in the information, processing system 10 according to the fifth embodiment in a case where the size of the part-selecting image 4320 is smaller than a threshold value.

First, the updater 4169 updates part-selecting image information of a part-selecting image 4320 so as to magnify the size of the part-selecting image 4320 displayed on the display 3 (step S4151).

Subsequently, the image information sender 151 sends the part-selecting image information updated by the updater 4169 to the display device 200, and then the image information receiver 251 receives the updated part-selecting image information from the information processing apparatus 100 (step S4153).

Then, the display controller 253 projects the updated part-selecting image 4321 on the display 3, based on the part-selecting image information received by the image information receiver 251 (step S4155).

As described above, according to the fifth embodiment, decrease in visibility of display parts 330 is prevented, as a proportion of the part-selecting image 4320 to the display 4310 image is enlarged to display the part-selecting image 4321 even in a case where the size of the display image 4310 as well as the size of the part-selecting image 4320 is small and therefore visibility of one or more display parts 330 included in the part-selecting image 4320 is limited.

Here, although the part-selecting image 4320 is magnified in the example of the fifth embodiment, the part-selecting image 4320 may be compressed by use of a similar method. In such a way, proper visibility of display parts 330 is preserved, as a proportion of the part-selecting image 4320 to the display image 4310 is compressed to display the part-selecting image 4321 even in a case where the size of the display image 4310 as well as the size of the part-selecting image 4320 is improperly big.

### Sixth Embodiment

In the sixth embodiment, an example of changing display positions of the part-selecting image 320 in accordance of displaying directions of the display device 200. Positions for the camera 105 provided on the information processing apparatus 100 to easily capture a display image 310 change depending on displaying directions (e.g. projecting from a regular position, a ceiling-suspended position, and a rear position) of the display device 200, as directions of the light source 217 change accordingly. According to the sixth embodiment, the part-selecting image 320 may be displayed at a position for the camera 105 provided on the information processing apparatus 100 to easily capture the part-selecting image 320, as displaying positions of the part selecting image 320 changes depending on the displaying directions of the display device 200.

In the following, elements that are different from the first embodiment will be mainly explained, whereas elements that have functions similar to the functions described in the first embodiment will be assigned with names and reference signs which are the same as in the first embodiment so as to omit duplicate explanations.

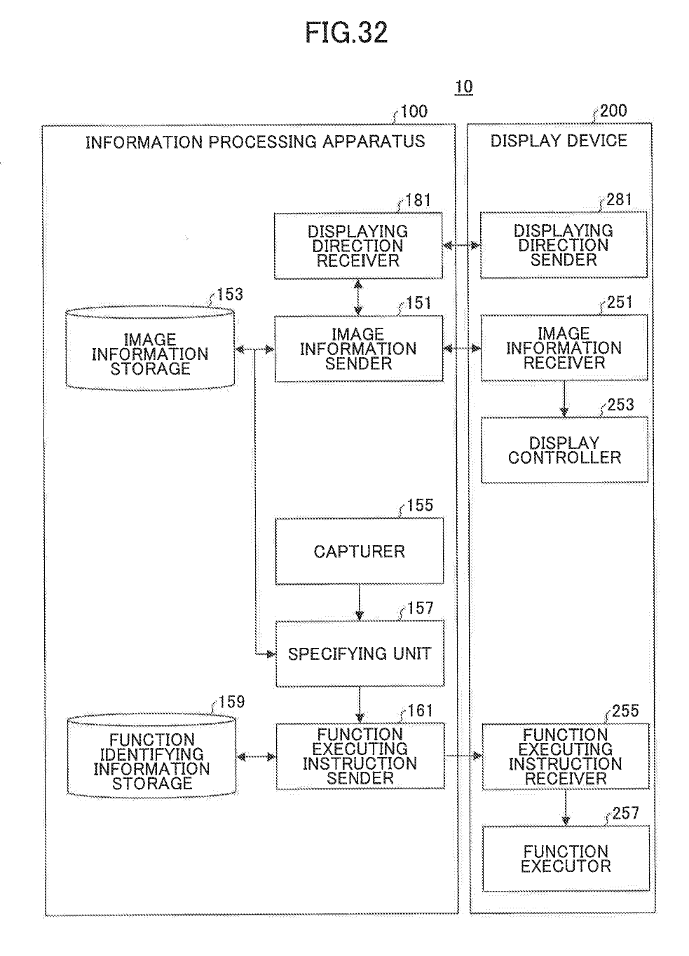

FIG. 32 is a block diagram illustrating an example of a functional configuration of the information processing system 10 according to the sixth embodiment. As illustrated in FIG. 32, in the sixth embodiment, the information processing apparatus 100 includes a displaying direction receiver 181 and the display device 200 includes a displaying direction sender 281.

The displaying direction receiver 181 provided in the information processing apparatus 100 receives from the display device 200 information regarding displaying direction of the display device 200. The displaying direction sender 281 provided in the display device 200 sends to the information processing apparatus 100 the information regarding displaying position of the display device 200.

Furthermore, in the sixth embodiment, the image information storage 153 stores information as described below.

TABLE 1

| | FUNC- | | DISPLAYING |
|---|---|---|---|
| PART | TION | | POSITION |
| ID | ID | DISPLAYING DIRECTION | (x, y) |
| P001 | F001 | REGULAR POSITION | 300, 400 |
| | | CEILING-SUSPENDED POSITION | 800, 700 |
| | | REAR POSITION | 800, 400 |
| P002 | F002 | REGULAR POSITION | 100, 100 |
| | | CEILING-SUSPENDED POSITION | 1000, 800 |
| | | REAR POSITION | 1000, 100 |
| P003 | F003 | REGULAR POSITION | 600, 400 |
| | | CEILING-SUSPENDED POSITION | 600, 400 |
| | | REAR POSITION | 600, 400 |
| . . . | . . . | . . . | . . . |

In Table 1, correspondence of displaying directions and displaying positions of the part-selecting image 320 is illustrated in a table format. Function IDs, displaying directions, and displaying positions are managed in association with respective part IDs. As multiple displaying directions and displaying positions are associated with one part ID as illustrated in Table 1, the display device 200 is capable of changing displaying positions of a display part 330, depending on the respective displaying directions. REGULAR POSITION represents a displaying direction in a case where the display device 200 is located at the comparable or lower level to the base of the display 3, CEILING-SUSPENDED POSITION represents a displaying direction in a case where the display device 200 is suspended from a ceiling. REAR POSITION represents a displaying direction in a case where the display device 200 is located behind the display 3.

Here, the function IDs in Table 1 stored in the image information storage 153 are illustrated for the convenience of explanation. The function. identifying information storage 159 stores the function IDs in association with the part IDs.

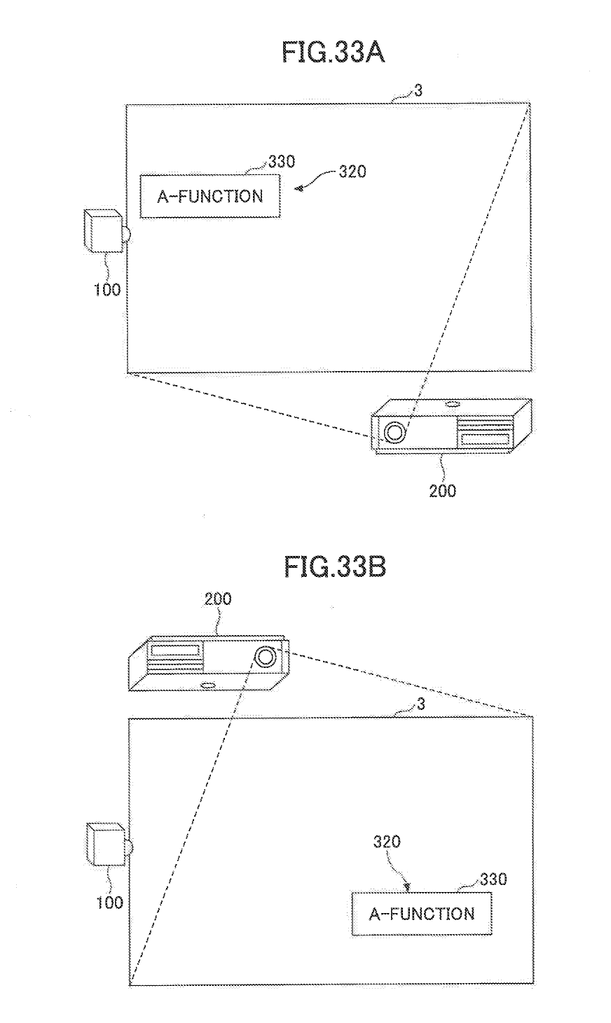

FIGS. 33A and 33B are drawings illustrating examples of a part-selecting image 320 according to the sixth embodiment. In FIG. 33A, an example of the part-selecting image 320 in a case where the displaying direction of the display device 200 is REGULAR POSITION is illustrated. In FIG. 33B, an example of the part-selecting image 320 in a case where the displaying direction of the display device 200 is CEILING-SUSPENDED POSITION is illustrated.

Although the part-selecting image 320 only includes the display part 330 for executing A-function in the examples of FIGS. 33A and 33B, the part-selecting image 320 is not limited to be as such and multiple display parts 330 for executing multiple functions may be displayed. As the displaying position of the display device 200 is REGULAR POSITION in FIG. 33A, the display part 330 is displayed at a displaying position suitable for REGULAR POSITION. That is to say, as the light source 217 is located at slower level to the base of the display 3, the display part 330 is displayed at a displaying position (e.g. upper area of the display 3) where the camera 105 provided on the information processing apparatus 100 easily captures an image of the display part 330. As the displaying position of the display device 200 is CEILING-SUSPENDED POSITION in FIG. 33B, the display part 330 is displayed at a displaying position (e.g. lower area of the display 3) suitable for CEILING-SUSPENDED POSITION.

The image information sender 151 sends part-selecting image information that corresponds to a displaying position received by the displaying direction receiver 181, to the display device 200.

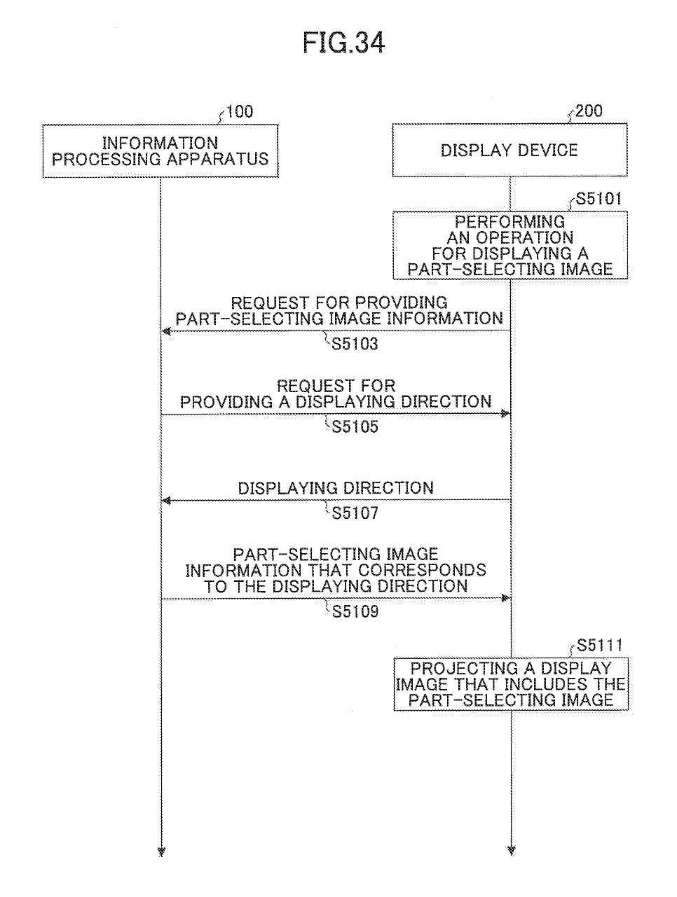

FIG. 34 is a sequence diagram illustrating an example of image projecting processing performed in the information processing system 10 according to the sixth embodiment. First, processes of steps S5101 and S5103 are the same as the processes of steps S101 and S103 in the sequence diagram illustrated in FIG. 8, respectively.

Subsequently, after a request for providing part-selecting image information of the default part-selecting image 320 is received by the information processing apparatus 100, the displaying direction receiver 181 requests the display device 200 for providing a displaying direction (step S5105).

Then, upon receiving from the information processing apparatus 100 the request for providing the displaying direction, the displaying direction sender 281 provided in the display device 200 sends the displaying position of the display device 200 to the information processing apparatus 100, and then the displaying direction receiver 181 receives the displaying direction from the display device 200 (step S5107). Here, the displaying direction of the display device 200 is preset on the display device 200 by a user. Alternatively, the display device 200 may capture an image of the display 3 using a camera provided on the display device 200 so that the displaying direction is automatically estimated by the display device 200 based on the positions of the camera and the lens 221. Further alternatively, the displaying direction may be preset on the information processing apparatus 100 by the user. In such a case, the information processing apparatus 100 need not acquire the displaying direction from the display device 200.

Then, the image information sender 151 acquires, from the image information storage 153, a displaying position that corresponds to the displaying direction received from the display device 200, and then sends, to the display device 200, part-selecting image information including the displaying position of the display part 330 step S5109).

A following process described as step S5111 is the same as the process of step S107 in the sequence diagram of the FIG. 3.

As described above, the display device 200 may display the display parts 330 at a variety of displaying positions depending on displaying directions according to the sixth embodiment, and therefore, even though there are limited area where the display part 330 is easily captured by the information processing apparatus 100, the display device 200 may display the part-selecting image 320 at a position where the display part 330 is easily captured by the information processing apparatus 100.

### Seventh Embodiment

In the seventh embodiment, an example of changing display parts 330 depending on an installation position of the information processing apparatus 100 will be explained. There may be a case where it is preferable to display a display part 330 which enables a user to perform an intuitive operation in relation to the installation position (i.e. left side or right side, or upper side or lower side of the display 3) of the information processing apparatus 100. According to the seventh embodiment, a user may perform an intuitive operation by way of changing display parts 330 depending on the installation positions of the information processing apparatus 100.

In the following, elements that are different from the first embodiment will be mainly explained, whereas elements that have functions similar to the functions described in the first embodiment will be assigned with names and reference signs which are the same as in the first embodiment so as to omit duplicate explanations.

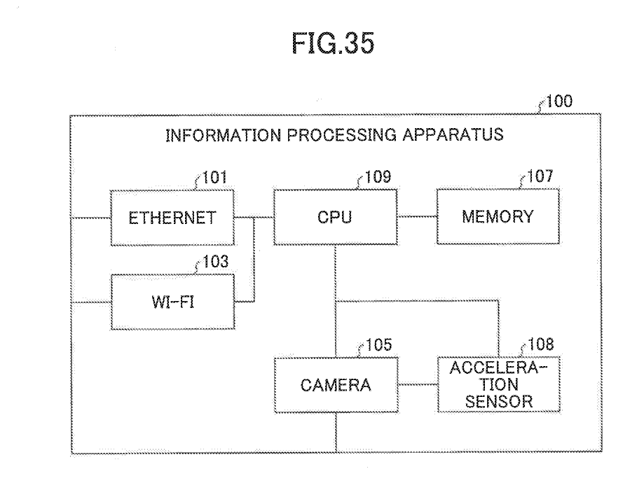

FIG. 35 is a block diagram illustrating an example of a hardware configuration of the information processing apparatus 100 according to the seventh embodiment. As illustrated in FIG. 35, the information processing apparatus 100 in the seventh embodiment includes an acceleration sensor 108. The acceleration sensor 108 is a unit for measuring acceleration (i.e. rate of change of velocity) of an object. The acceleration sensor 108 preferably detects acceleration in dimensions of more than three axes. The information processing apparatus 100 is capable of detecting tilt of itself based on a ratio of gravitational force in the directions of the three axes detected by the acceleration sensor 108.

On the other hand, the orientation of the camera 105 provided on the information processing apparatus 100 is fixed (stored in the memory 107 provided in the information processing apparatus 100). Hence, the information processing apparatus 100 is capable of detecting the position of itself in relation to the display 3 based on the current tilt of the information processing apparatus 100 and the orientation of the camera 105 provided on the information processing apparatus 100.

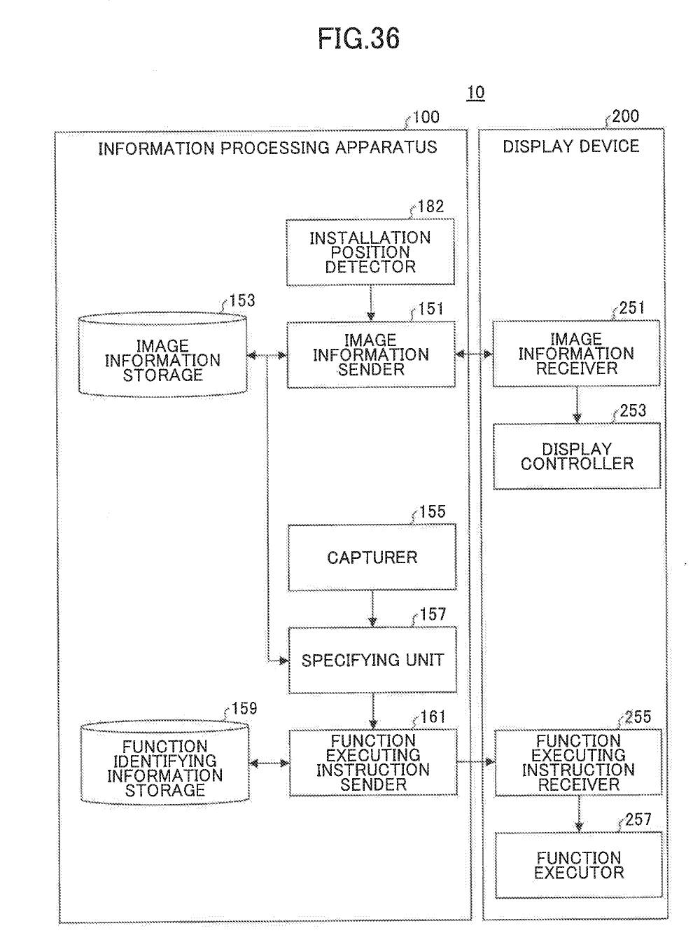

FIG. 36 is a block diagram illustrating an example of a functional configuration of the information processing system. 10 according to the seventh embodiment. As illustrated in FIG. 36, the information processing apparatus 100 includes an installation position detector 182 in the seventh embodiment.

The installation position detector 182 provided in the information processing apparatus 100 detects the installation position of the information processing apparatus 100 in relation to the display 3. The installation positions are represented by UPPER POSITION, LOWER POSITION, LEFT-SIDE POSITION, and RIGHT-SIDE POSITION. Here, instead of detecting the installation position by use of the acceleration sensor 108, the installation position maybe preset on the information processing apparatus 100 by a user.

In the seventh embodiment, the image information storage 153 further stores information as described below.

TABLE 2

| FUNCTION ID | INSTALLATION POSITION | PART ID |
|---|---|---|
| F001 | UPPER POSITION | P001-1 |
| | LOWER POSITION | P001-2 |
| | LEFT-SIDE POSITION | P001-3 |
| | RIGHT-SIDE POSITION | P001-4 |
| F002 | UPPER POSITION | P002-1 |
| | LOWER POSITION | P002-2 |
| | LEFT-SIDE POSITION | P002-3 |
| | RIGHT-SIDE POSITION | P002-4 |
| F003 | UPPER POSITION | P003-1 |
| | LOWER POSITION | P003-2 |
| | LEFT-SIDE POSITION | P003-3 |
| | RIGHT-SIDE POSITION | P003-4 |
| . . . | . . . | . . . |

In Table 2, correspondence of the installation positions of the information processing apparatus 100 and display parts 330 is illustrated in a table format. The installation positions of the information processing apparatus 100 and the display parts 330 are manages in association with respective function IDs. In other words, multiple part IDs are associated with a display part 330 for executing the same function. As display parts 330 are associated with respective installation positions of the information processing apparatus 100 as illustrated in Table 2, the display device 200 is capable of displaying different display parts 330, depending on the respective installation positions of the information processing apparatus 100.

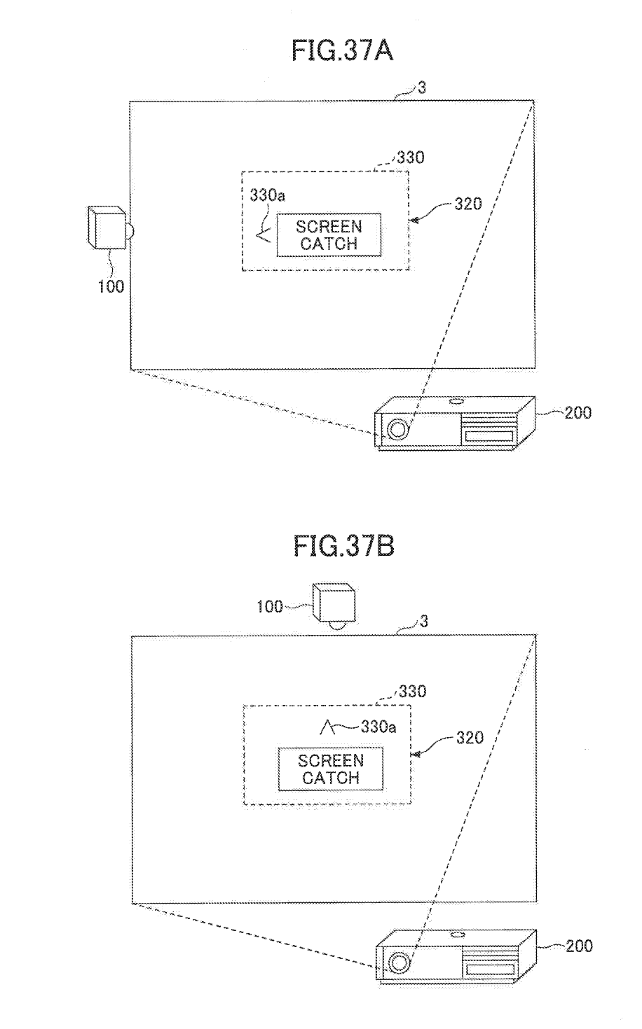

FIGS. 37A and 37B are drawings illustrating examples of the part-selecting image 320 according to the seventh embodiment. In FIG. 37A, an example of the part-selecting image 320 in case where the information processing apparatus 100 is installed, on the left-side position in relation to the display 3 is illustrated in FIG. 37B, an example of the part-selecting image 320 in a case where the information processing apparatus 100 is installed on the upper position in relation to the display 3 is illustrated. In FIG. 37A, the installation position detector 182 detects that the information processing apparatus 100 is installed, on the left-side position in relation to the display 3, as gravitational force is detected toward the right of the direction from the center of the information processing apparatus 100 to the camera 105. In FIG. 37B, the installation position detector 182 detects that the information processing apparatus 100 is installed on the upper position in relation to the display 3, as gravitational force is detected toward the same direction from the center of the information processing apparatus 100 to the camera 105.

In a case where a display part having “directional property” in the design properly indicates a direction in accordance with the property so as to help a user understand an operation of a part-selecting image 320 or a behavior of the display part 330, a user may be able to perform an intuitive operation. In the example of FIGS. 37A and 37B, a display part 330 for executing a function for inputting information on the display 3 to the information processing apparatus 100 (i.e. capturing function, or importing function). In such a case, offering a direction to the information processing apparatus 100 is effective for intuitively indicating that “information is input to the information processing apparatus”.

In FIGS. 37A and 37B, a display part 330 having letters of “SCREEN CATCH” is displayed. “SCREEN CATCH” indicates that the information processing apparatus 100 acquires information provided on the display 3. A mark 330a offers a direction to the information processing apparatus 100. In FIG. 37A, the display part 330 includes a mark 330a indicative of the left, as the information processing apparatus 100 is located on the left side of the display 3. In FIG. 37B, the display part 330 includes a mark 330a indicative of the above, as the information processing apparatus 100 is located above the display 3. Here, besides the examples illustrated in FIGS. 37A and 37B, a variety of display parts 330 may be displayed depending on an installation position of the information processing apparatus 100.

The image information sender 151 retrieves, from the image information storage 153, a display part 330 that corresponds to the installation position of the information processing apparatus 100 detected by the installation position detector 182, and then sends part-selecting image information including the display part 330 to the display device 200.

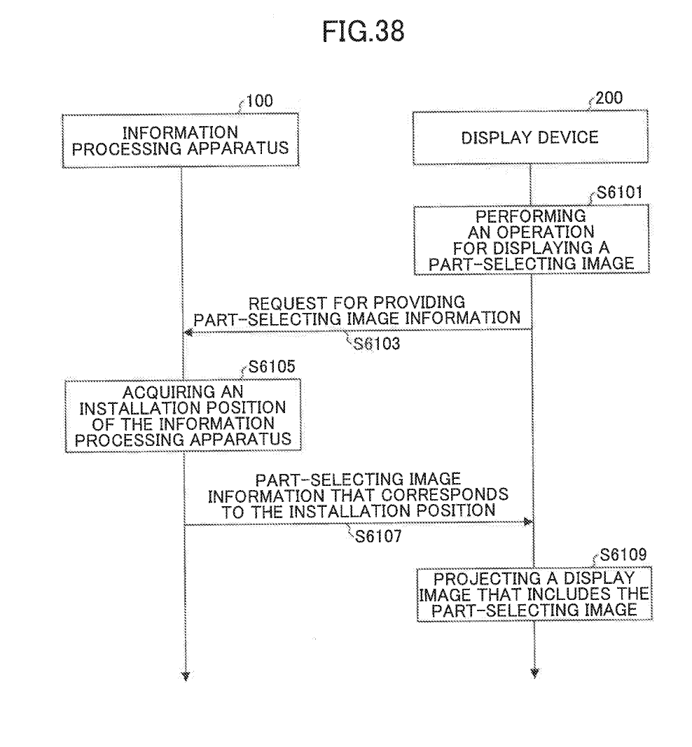

FIG. 38 is a sequence diagram illustrating an example of image projecting processing performed in the information processing system 10 according to the seventh embodiment. First, processes of steps S6101 and S6103 are the same as the processes of steps S101 and S103 in the sequence diagram illustrated in FIG. 8, respectively.

Subsequently, after the information processing apparatus 100 receives the request for providing part-selecting image information of a default part-selecting image 320, the image information sender 151 acquires the installation position of the information processing apparatus 100 from the installation position detector 182 (step S6105).

Next, the image information sender 151 acquires, from the image information storage 153, a display part 330 that corresponds to the installation position of the information processing apparatus 100 acquired from the installation position detector 182, and then sends part-selecting image information including the display part 330 to the display device 200 (step S6107).

A following process in step S6109 is the same process in step S107 in the sequence diagram illustrated in FIG. 8.

As described above, according to the seventh embodiment, a user may perform an intuitive operation by way of switching display parts 330 having “directional property” in the respective designs, depending on installation positions of the information processing apparatus 100, etc.

### Eighth Embodiment

In the eighth embodiment, an example of changing display parts 330 depending on brightness-levels of the display 3 is explained. Display parts 330 that can be clearly seen by a user are different depending on brightness-levels of the display 3. In the eighth embodiment, the display device 200 is capable of displaying display parts 330 that can be clearly seen by a user by way of changing display parts 330 depending on brightness-levels of the display 3.

In the following, elements that are different from the first embodiment will he mainly explained, whereas elements that have functions similar to the functions described in the first embodiment will be assigned with names and reference signs which are the same as in the first embodiment so as to omit duplicate explanations.

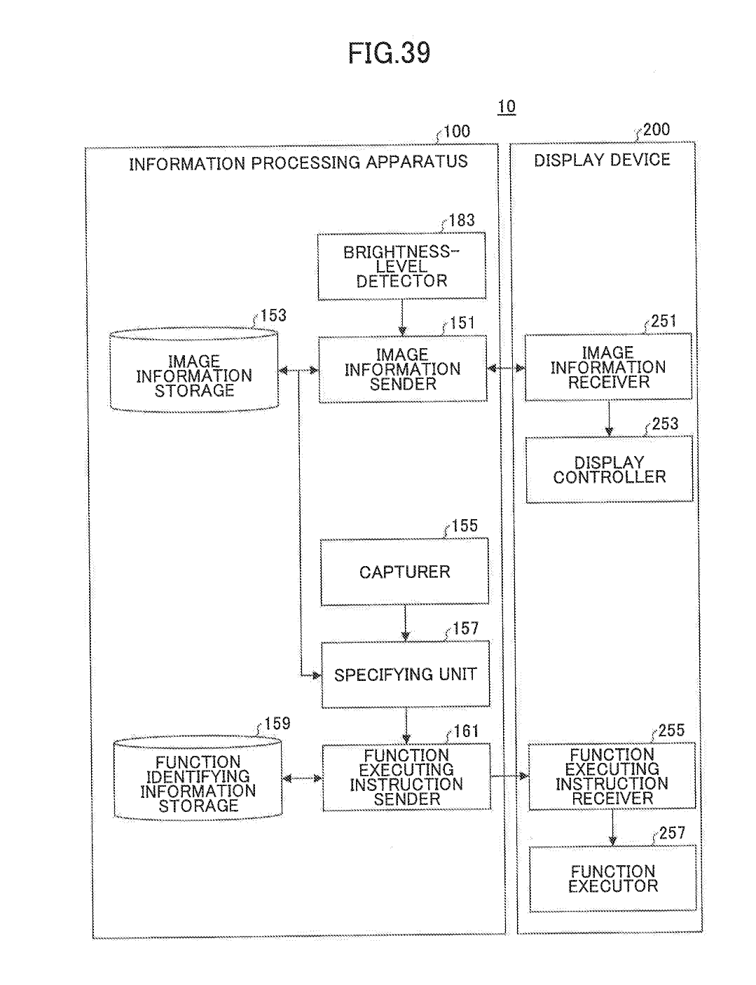

FIG. 39 is a block diagram illustrating an example of a functional configuration of the information processing system 10 according to the eighth embodiment. As illustrated in FIG. 39, in the eighth embodiment, the information processing apparatus 100 includes brightness-level detector 183.

The brightness-level detector 183 provided in the information processing apparatus 100 detects a brightness-level of the display 3 by use of the camera 105 provided on the information processing apparatus 100. For example, a brightness-level is detected by way of converting shutter speed and gain of the camera 105 to brightness. Alternatively, the display device 200 may display white pixels on the entire area of the display 3, and then detect a brightness-level based on a pixel value (i.e. density) of an image of the display 3 captured by the camera 105 with predetermined shutter speed and gain.

In the eighth embodiment, the image information storage 153 further stores information as described below.

TABLE 3

| | BRIGHTNESS- | |
|---|---|---|
| FUNCTION ID | LEVEL OF DISPLAY | PART ID |
| F001 | MORE THAN 1000 lx | P001-1 |
| | LESS THAN 1000 lx | P001-2 |
| F002 | MORE THAN 1000 lx | P002-1 |
| | LESS THAN 1000 lx | P002-2 |
| F003 | MORE THAN 1000 lx | P003-1 |
| | LESS THAN 1000 lx | P003-2 |
| . . . | . . . | . . . |

In Table 3, correspondence of brightness-levels of the display 3 and display parts 330 is illustrated in a table format. Brightness-levels of the display 3 and display parts 330 are managed in association with respective function IDs. As different display parts 330 correspond to respective brightness-levels of the display 3 as illustrated in Table 3, the display device 200 is capable of displaying different display parts 330 depending on brightness-levels of the display 3. Color combinations, etc., of display parts 330 that can be clearly seen by a user are different in either case where the display 3 is bright enough or the display 3 is dark. For example, in a case where the 3 is bright, a display part 330 in darker tone can be seen more clearly, and in a case where the display 3 is dark, a display part 330 in brighter tone can be seen more clearly. Therefore, display parts 330 that can be clearly seen by a user may be displayed by way of changing display parts 330 based on threshold values regarding brightness-levels.

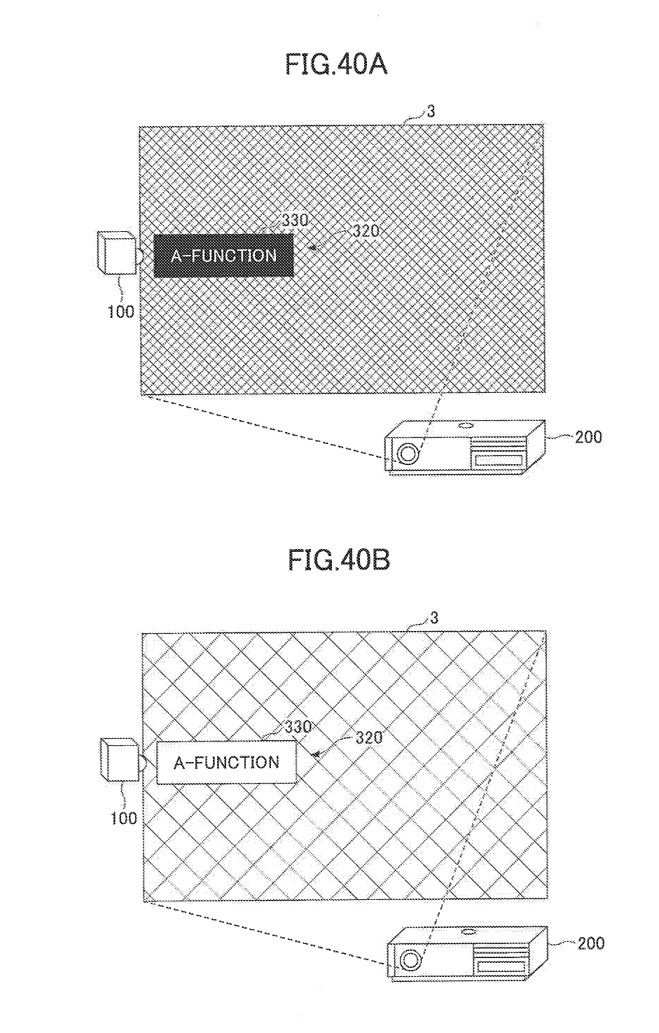

FIGS. 40A and 40B are drawings illustrating examples of a part-selecting image 320 according to the eighth embodiment. In FIG. 40A, an example of the part-selecting image 320 in a case where the brightness-level of the display 3 is greater than a predetermined, threshold value (e.g. 1000 1×) is illustrated. In FIG. 40B, an example of the part-selecting image 320 in a case where the brightness-level of the display 3 is smaller than a predetermined threshold value is illustrated. In a case where the brightness-level of the display 3 is greater than a threshold value, a blackish display part 330 with white letters is displayed, whereas, in a case where the brightness-level of the display 3 is smaller than a threshold value, a whitish display part 330 with black letters, which is for executing the same function, is displayed. In such a way, user may clearly see the display 3 no matter which the display 3 is dark or bright.

The image information sender 151 retrieves, from the image information storage 153, a display part 330 that corresponds to a brightness-level of the display 3 detected by the brightness-level detector 183, and then sends the display part 330 to the display device 200.

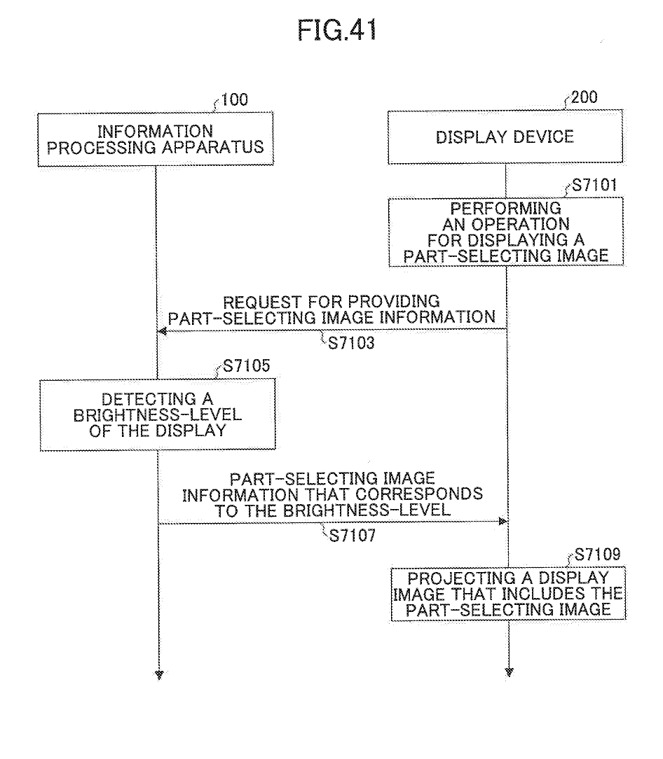

FIG. 41 is a sequence diagram illustrating an example of image projecting processing performed in the information processing system 10 according to the eighth embodiment. First, processes of steps S7101 and S7103 are the same as the processes of the steps S101 and S103 in the sequence diagram illustrated in FIG. 8.

Subsequently, after the information processing apparatus 100 receives the request for providing part-selecting image information of a default display part 330, the image information sender 151 acquires a brightness-level of the display 3 from the brightness-level detector 183 (step S7105).

Then, the image information sender 151 acquires, from the image information storage 153, a display part 330 that corresponds to the brightness-level of the display 3 acquired from the brightness-level detector 183, and then sends the part-selecting image information including the display part 330 to the display device 200 (step S7107).

A following process described as step S7019 is the same as the process of step S107 in the sequence diagram illustrated in FIG. 8.

As described above, according to the eighth embodiment, display parts 330 with high visibility may be displayed by way of changing display parts 330 using the information processing apparatus 100, depending on brightness-levels of the display 3.

### Ninth Embodiment

In an example according to the ninth embodiment, in a case where a predetermined display-restricted item is being displayed, the display device 200 stops displaying the display-restricted item. There may be a case where the information processing apparatus 100 sends part-selecting image information to the display device 200 for displaying a display part 330 while the display device 200 is displaying the same type of display part 330 (display item). According to the ninth embodiment, the display device 200 stops displaying a predetermined display-restricted item in a case where the information processing apparatus 100 sends part-selecting image information to the display device 200 for displaying a display part 330 while the display device 200 is displaying the same type of display part 330 (display item), so that a user is not confused when performing operations.

In the following, elements that are different from the first embodiment will be mainly explained, whereas elements that have functions similar to the functions described in the first embodiment will be assigned with names and reference signs which are the same as in the first embodiment so as to omit duplicate explanations.

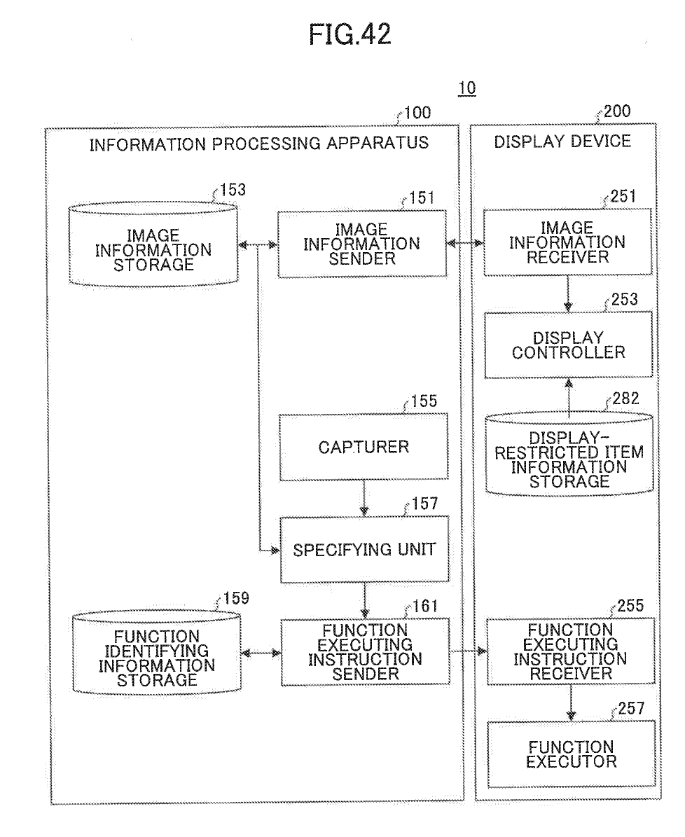

FIG. 42 is a block diagram illustrating an example of a functional configuration of the information processing system 10 according to the ninth embodiment. As illustrated in FIG. 42, the display device 200 includes display-restricted item information storage 282 in the ninth embodiment. The display-restricted item information storage 282 stores display items of the display device 200 which may be restricted, in association with display parts 330 (i.e. part IDs). In other words, the display-restricted item information storage 282 stores display items to be displayed by the display device 200 which may not be desired to be displayed when the information processing apparatus 100 displays a predetermined display part 330 by use of the display device 200.

Further, in the ninth embodiment, the image information storage 153 stores information as described below.

TABLE 4

| PART ID | FUNCTION ID | DISPLAY PRIORITIZATION |
|---|---|---|
| P001 | F001 | PRIORITIZED |
| P002 | F002 | PRIORITIZED |
| P003 | F003 | — |

In Table 4, information as to whether to prioritize respective parts 330, which is displayed by the information processing apparatus 100 through the display device 200, to display-restricted items being displayed by the display device 200 is illustrated in a table format. Here, the table is stored in the image information storage 153. In a case where an display part 330 is supposed to be displayed in priority to a display-restricted item as illustrated in Table 4, the information processing apparatus 100 sends information indicative of the priority along with a part ID to the display device 200, so that the display device 280 refers to the display-restricted item information storage 282 and, if necessary, stops displaying the display-restricted item.

For example, in a case where the information processing apparatus 100 displays by use of the display device 200 a keyboard for a user input while another software keyboard is being displayed by the display device 200, the user may be confused which keyboard as supposed to be operated. Here, the information processing apparatus 100 sends information indicative of restricting the display of the display-restricted item to the display device 200 when the information processing apparatus 100 displays the keyboard by use of the display device 200. In such a way, the display device 200 stops displaying the software keyboard.

The image information sender 151 sends to the display device 200 a display-restricting instruction (including a part ID) along with a part-selecting image, in a case where the part-selecting image includes a “PRIORITIZED” display part.

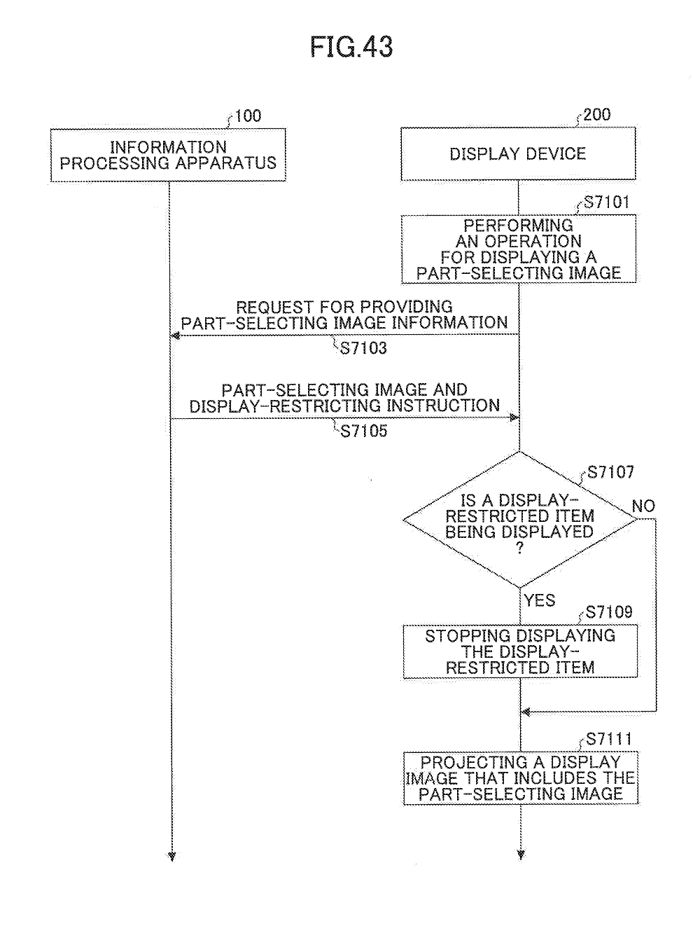

FIG. 43 is a sequence diagram illustrating an example of image projecting processing performed in the information processing system 10 according to the ninth embodiment. First, processes of steps S7101 and S7103 are the same as the processes of steps S101 and S103 in the sequence diagram illustrated in FIG. 8, respectively.

Subsequently, upon sending a part-selecting image, the image information sender 151 sends a display-restricting instruction to the display device 200, in a case where, referring to the image information storage 153, the part-selecting image includes a “PRIORITIZED” display part (step S7105). The image information receiver 251 provided in the display device 200 receives the part-selecting image and the display-restricting instruction.

Then, upon detecting that the display-restricting instruction is received, the display controller 253 provided in the display device 200 determines whether a display-restricted item, which is stored in the display-restricted item information storage 282, is included in currently displayed display items (step S7109).

In a case where a result of the determination in step S7109 is YES, the display controller 253 provided in the display device 200 stops displaying the display-restricted item (step S7109).

In a case where the result of the determination in step S7109 is NO, the display controller 253 provided in the display device 200 does not stop displaying the display-restricted item.

A following process described as step S7111 is the same as the process of step S107 in the sequence diagram illustrated in FIG. 8.

As described above, according to the ninth embodiment, in a case where a display-restricted item, which causes a problem when a user performs an operation on a part-selecting image 320, is being displayed by the display device 200, the information processing apparatus 100 may have the display device 200 stop displaying the display-restricted item.

### Tenth Embodiment

In an example according to the tenth embodiment, when the information processing apparatus 100 detects installation deviation, the display device 200 performs re-calibration. Although the display device 200 performs calibration so that the information processing apparatus 100 precisely detects a position of the instructing operation device 5, there may be a case where a user, etc., unintentionally moves the information processing apparatus 100. According to the tenth embodiment, as the display device 200 automatically performs calibration, the information processing apparatus 100 is capable of precisely detecting a position of the instructing operation device 5 even in an event of installation deviation of the information processing apparatus 100.

In the following, elements that are different from the first embodiment will be mainly explained, whereas elements that have functions similar to the functions described in the first embodiment will be assigned with names and reference signs which are the same as in the first embodiment so as to omit duplicate explanations.

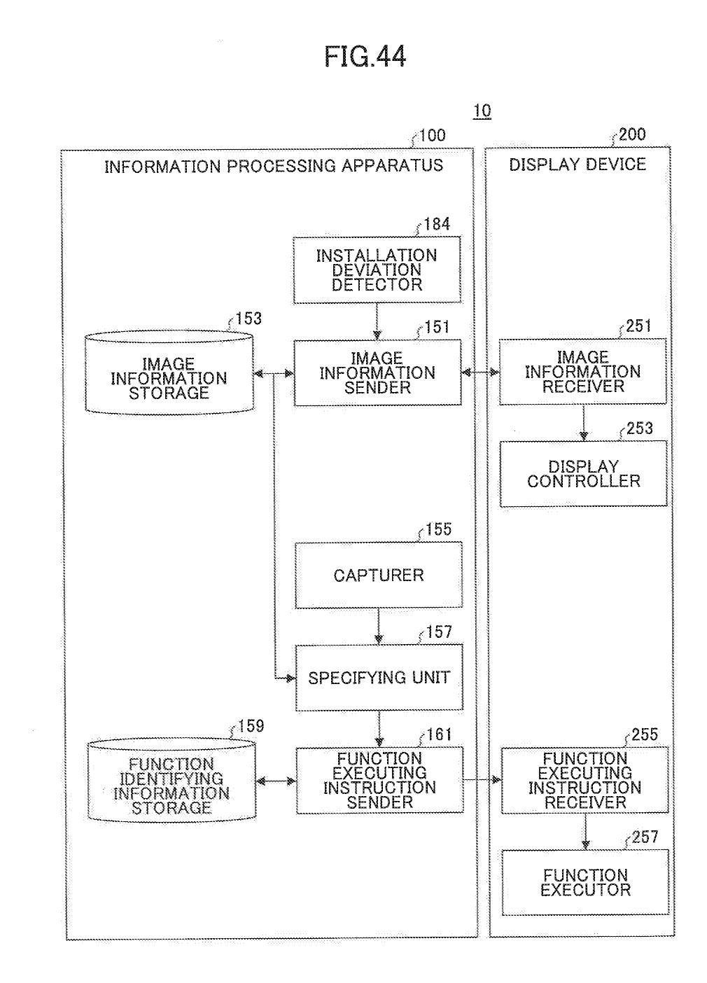

FIG. 44 is a block diagram illustrating an example of a functional configuration of the information processing system 10 according to the tenth embodiment. As illustrated in FIG. 44, the information processing apparatus 100 includes an installation deviation detector 184 in the tenth embodiment. The installation deviation detector 184 supervises acceleration detected by the acceleration sensor 108 illustrated in FIG. 35 and detects installation deviation of the information processing apparatus 100, responding to a detection of a change in acceleration which is greater than a threshold value.

When the installation deviation detector 184 detects installation deviation, the image information sender 151 sends a part-selecting image information including a display part 330 for executing calibration. In other words, the image information sender 151 sends a part-selecting image information including a display part 330 for asking a user whether to perform calibration. Here, the calibration relates to specifying/detecting the instructing operation device 5 that performs an instructing operation on the display 3.

For example, the display device 200 displays an “x” mark at a predetermined position of the display 3, and then a user points at the “x” mark using the instructing operation device 5. As the “x” mark is pointed at by the instructing operation device 5 in captured image of the display 3 obtained by the capturer 155 provided on the information processing apparatus 100, the information processing apparatus 100 is capable of precisely detecting the position of the instructing operation device 5 by way of calibration even in an event of installation deviation.

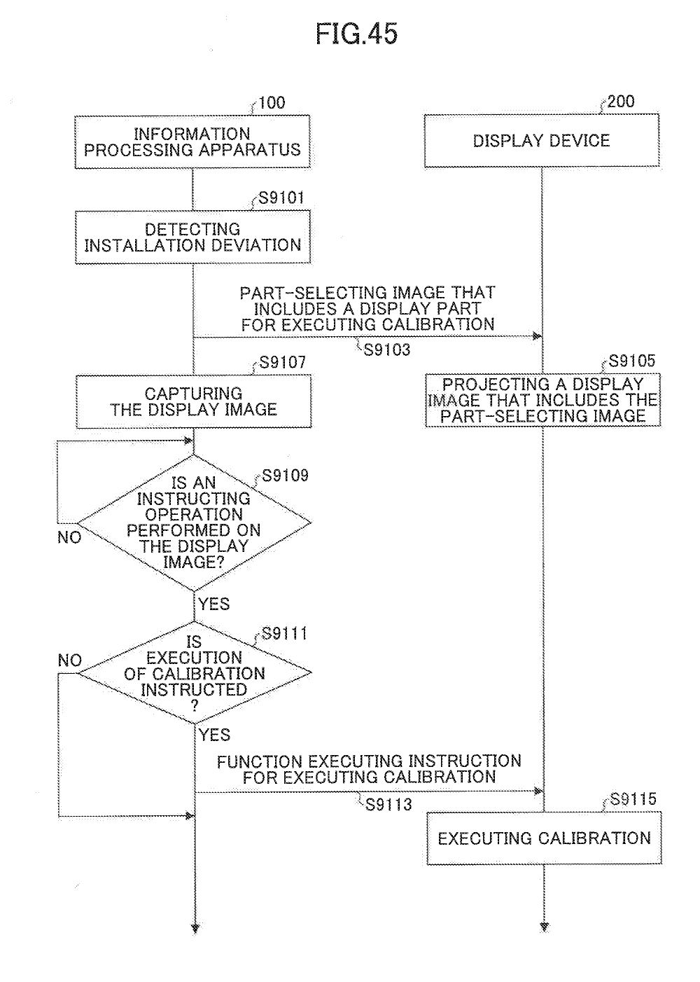

FIG. 45 is a sequence diagram illustrating an example of image projecting processing performed in the information processing system 10 according to the tenth embodiment.

The installation deviation detector 184 detects installation deviation of the information processing apparatus 100 (step S9101).

Responding to the detection of the installation deviation, the image information sender 151 provided in the information processing apparatus 100 sends a part-selecting image information including a display part 330 for executing calibration to the display device 200 (step S9103). The image information receiver 251 provided in the display device 200 receives the part-selecting image information including the display part 330 for executing calibration.

Then, the display controller 253 provided in the display device 200 projects a display image 310 including a part-selecting image 320, based on the part-selecting image information received by the image information receiver 251.

Then, the capturer 155 captures the display image 310 displayed on the display 3 (step S9107).

Then, the specifying unit 157 determines whether an instructing operation is performed on any of the one or more display parts 330 included in the part-selecting image 320, based on an instructing operation point of the part-selecting image 320 displayed on the display 3 by the display device 200, where an instructing operation is performed (step S9109). The display part 330, where an instructing operation is performed, is specified by way of determining whether coordinates on part-selecting image information corresponding to coordinates of the instructing operation point is included in sets of position coordinates of any of the display parts 330 indicated by the part-selecting image arrangement information.

In a case where an instructing operation is not performed on any display parts 330 (NO in step S9109), the sequence returns to the process of step S9109.

In a case where an instructing operation is performed on a display part (YES in step S9109), the specifying unit 157 determines whether the display part 330 on which the instructing operation is performed is the display part 330 for executing calibration (step S9111). The display part 330 is specified by way of determining whether the coordinates on the part-selecting image information corresponding to the coordinates of the instructing operation point is included in a set of position coordinates of the display part 330 for executing calibration, which is indicated by the part-selecting image arrangement information.

In a case where a result of the determination in step S9111 is NO, for example when a cancel button is selected by the user, the function executing instruction sender 161 acquires a function ID and sends a function executing instruction for executing a function indicated by the function ID. In the example above, the display device 200 terminates the display of the part-selecting image 320 for executing calibration.

In a case where the result of the determination in step S9111 is YES, the function executing instruction sender 161 acquires function ID for executing calibration and sends a function executing instruction for executing calibration as indicated by the function ID.

The function executing instruction receiver 255 provided in the display device 200 receives the function executing instruction for executing calibration from the information processing apparatus 100, and then the function executor 257 executes calibration in accordance with the function executing instruction received by the function executing instruction receiver 255 (step S9115).

As illustrated above, according to the tenth embodiment, as the part-selecting image 320 for executing calibration is displayed in an event of installation deviation of the information processing apparatus 100, it is prevented that a position of an instructing operation and a position detected (specified) by the information processing apparatus 100 disagree.

Further, the present invention is not limited to these embodiments, but various variations and modifications may be made without departing from the scope of the present invention.

Although the description of the above embodiments explains a case where the display device 200 is a projector, the display device 200 may be, for example, an electronic whiteboard. In a case where the display device 200 is an electronic whiteboard, the specifying unit 157 may be provided in the display device 200, as generally an electronic whiteboard is provided with a touch panel function that enables detecting coordinates of a touched position of a display.

Further, in the examples of configurations illustrated in in FIGS. 4, 11, 16, 23, 27, 32, 36, 39, 42, 44, etc., in the above embodiments, processing unit is divided in accordance with main functions of the information processing apparatus 100 and the display device 200 in order to help understanding processing performed in the information processing apparatus 100 and the display device 200. However, the present invention is not limited to the way the processing unit is divided into smaller units or the names of the respective units. The processing unit of the information processing apparatus 100 and the display device 200 may be divided into even smaller units in accordance with processing details. Furthermore, the processing unit of the information processing apparatus 100 and the display device 200 may be divided into units so that each unit performs a broader range of processing.

Further, some of the functions of the information processing apparatus 100 may be provided in the display device 200, and some of the functions of the display device 200 may be provided in the information processing apparatus 100. Alternatively, the information processing apparatus 100 and the display device 200 may be embodied in a single apparatus.

Further, the information processing system may include multiple information processing apparatuses 100 or display devices 200.

Further, the image information storage 153 and the function identifying information storage 159 provided in the information processing system 10 may be provided on the network 2.

(Program)

The programs executed by the information processing apparatus 100 and the display device 200 according to the embodiments/modifications as described above (herein after referred to as “each device described in the above embodiments/modifications”) may be stored, in an installable and executable file format, in a computer-readable storing medium such as a CD-ROM, a CD-R, a memory card, a Digital Versatile Disk (DVD), an a Flexible Disk (FD), for the purpose of distribution.

Further, the programs executed by each device described in the above embodiments/modifications may be stored in a computer connected to a network such as the Internet so as to be downloaded via the network, for the purpose of distribution. Further, the programs executed by each device described in the above embodiments/modifications may be distributed via a network such as the Internet. Further, the programs executed by each device described in the above embodiments/modifications may be preliminarily embedded in a ROM, etc., for the purpose of distribution.

The programs executed by each device described in the above embodiments/modifications are modularly configured to embody each unit as described above on a computer. An actual hardware may be, for example, a CPU that retrieves the programs from a ROM and executes the programs on a RAM so as to embody each unit as described above on a computer.

It should be noted that a person skilled in the field of information processing technology may employ the present invention using application specific integrated circuits (ASIC) or an apparatus in which circuit modules are connected. Further, each of the functions (units) may be implemented by one or more circuits. It should be noted that, in this specification, the circuit may include a processor programed by software to execute the corresponding functions and hardware which is designated to execute the corresponding functions such as the ASIC and the circuit module.

What is claimed is:

1. An information processing system comprising:
an information processing apparatus; and
a display device,
wherein the information processing apparatus includes
an image information sender configured to send, to the display device, part-selecting image information provided for displaying a part-selecting image including one or more display parts; and
a function executing instruction sender configured to send, to the display device, a function executing instruction for executing a function corresponding to one of the one or more display parts, the one of the one or more display parts being specified by an instructing operation performed on the part-selecting image displayed on a display by the display device, and
wherein the display device includes
an image information receiver configured to receive the part-selecting image information from the information processing apparatus;
a display controller configured to display the part-selecting image on the display, based on the received part-selecting image information;
a function executing instruction receiver configured to receive the function executing instruction from the information processing apparatus; and
a function executor configured to execute the function in accordance with the received function executing instruction.

2. The information processing system according to claim 1,
wherein, the display device further includes
a type information sender configured to send, to the information processing apparatus, type information indicative of a type of the information processing apparatus,
wherein the information processing apparatus further includes
an image information storage configured to store the type information and the part-selecting image information provided for displaying the part-selecting image including the one or more display parts, in a way that the type information and the part-selecting image information correspond to each other; and
a type information receiver configured to receive the type information from the information processing apparatus, and
wherein the image information sender sends, to the display device, the part-selecting image information corresponding to the received type information.

3. The information processing system according to claim 1,
wherein the display device further includes
a mode information sender configured to send, to the information processing apparatus, mode information indicative of a mode of the information processing apparatus,
wherein the information processing apparatus further includes
an image information storage configured to store the mode information and the part-selecting image information provided for displaying the part-selecting image including the one or more display parts, in a way that the mode information and the part-selecting image information correspond to each other; and
a mode information receiver configured to receive the mode information from the display device, and
wherein the image information sender sends, to the display device, the part-selecting image information corresponding to the received mode information.

4. The information processing system according to claim 1,
wherein the display device further includes
a completion information sender configured to send, to the information processing apparatus, completion information indicating that execution of the function in accordance with the received function executing instruction is completed,
wherein the information processing apparatus further includes
a completion information receiver configured to receive the completion information from the display device; and
an updater configured to update the part-selecting image information provided for displaying the part-selecting image based on the received completion information, so as to update content of the part-selecting image displayed on the display,
wherein the image information sender sends the updated part-selecting image information to the display device,
wherein the image information receiver receives the updated part-selecting image information from the information processing apparatus, and
wherein the display controller displays the updated part-selecting image on the display, based on the updated part-selecting image information.

5. The information processing system according to claim 1,
wherein the display controller displays a display image including the part-selecting image on the display, based on the received part-selecting image information,
wherein the information processing apparatus further includes
a capturer configured to capture the part-selecting image displayed on the display in order to obtain an image;
a determiner configured to determine whether a size of the part-selecting image appearing on the image obtained by he capturer meets a predetermined condition; and
an updater configured to update the part-selecting image information provided for displaying the part-selecting image so as to change the size of the part-selecting image displayed on the display, responding to a determination of the determiner that the size of the part-selecting image does not meet the predetermined condition,
wherein the image information sender sends the updated part-selecting image information to the display device,
wherein the image information receiver receives the updated part-selecting image information from the information processing apparatus, and
wherein the display controller displays the display image including the part-selecting image in the changed size on the display, based on the updated part-selecting image information.

6. The information processing system according to claim 5,
wherein the determiner determines whether the size of the part-selecting image appearing on the image obtained by the capturer is smaller than a predetermined threshold,
wherein the updater updates the part-selecting image information provided for displaying the part-selecting image so as to magnify the size of the part-selecting image displayed on the display, responding to a determination of the determiner that the size of the part-selecting image is smaller than the predetermined threshold, and
wherein the display controller displays the display image including the part-selecting image in the magnified size on the display, based on the updated part-selecting image information.

7. The information processing system according to claim 1,
wherein the display device further includes
a displaying direction sender configured to send, to the information processing apparatus, a displaying direction from which the part-selecting image is displayed,
wherein the information processing apparatus further includes
an image information storage configured to store the part-selecting image information provided, for displaying the part-selecting image including the one or more display parts and configured to store the displaying direction and a displaying position of the one of the one or more display parts, in a way that the displaying direction and the displaying position correspond to each other; and
a displaying direction receiver configured to receive the displaying direction from the display device, and
wherein the image information sender retrieves, from the image information storage, the displaying position corresponding to the displaying direction received by the displaying direction receiver, and when sends, to the display device, the part-selecting image information, based on which the one of the one or more display parts is displayed at the displaying position.

8. The information processing system according to claim 1,
wherein the information processing apparatus further includes
an installation position detector configured to detect one of at least one installation position relative to the display; and
an image information storage configured to store the part-selecting image information provided for displaying the part-selecting image including the one or more display parts and configured to store the at least one installation position and at least one display part including the one or more display parts, in a way that the at least one installation position and the at least one display part correspond to each other, and
wherein the image information sender retrieves, from the image information storage, one of the at least one display part corresponding to the one of the at least one installation position detected by the installation position detector, and then sends, to the display device, the part-selecting image information, based on which the one of the at least one display part is displayed.

9. The information processing system according to claim 1,
wherein the information processing apparatus further includes
a brightness-level detector configured to detect one of at least one brightness-level of the display; and
an image information storage configured to store the part-selecting image information provided for displaying the part selecting image including the one or more display parts and configured to store the at least one brightness-level and at least one display part including the one or more display parts, in a way that the at least one brightness-level and the at least one display part correspond to each other, and
wherein the image information sender retrieves, from the image information storage, one of the at least one display part corresponding to the one of the at least one brightness-level detected by the brightness-level detector, and then sends, to the display device, the part-selecting image information, based on which the one of the at least one display part is displayed.

10. The information processing system according to claim 1,
wherein the image information sender sends, to the display device, a display-restricting instruction together with part-selecting image information provided for displaying one or more display parts including a predetermined display part,
wherein the image information receiver receives, from the information processing apparatus, the part-selecting image information and the display-restricting instruction, and
wherein the display controller stops displaying a predetermined display restricted item in a case where the predetermined display-restricted item is being displayed on the display, upon receiving the display-restricting instruction.

11. The information processing system according to claim 1,
wherein the information processing apparatus further includes
an installation deviation detector configured to detect installation deviation of the information processing apparatus, and
wherein the image information sender sends, to the display device, part-selecting image information provided for displaying one or more display parts including a display part for executing calibration which is performed at a time of installing the information processing apparatus, in an event where the installation deviation detector detects installation deviation.

12. The information processing system according to claim 1,
wherein the information processing apparatus further includes
a function identifying information storage configured to store display part identifying information for identifying a display part out of the one or more display parts and function identifying information for identifying a function corresponding to the display part, in a way that the display part identifying information and the function identifying information correspond to each other, and
wherein the function executing instruction is an instruction to execute the function corresponding to the display part specified by the instructing operation, the function being identified by the function identifying information and the specified display part being identified by the display part identifying information corresponding to the function identifying information.

13. The information processing system according to claim 1,
wherein the information processing apparatus further includes
a specifying unit configured to specify, out of the one or more display parts, a display part on which the instructing operation is performed, based on an instructing operation point, which is a position on which the instruction operation is performed in the part-selecting image displayed on the display.

14. The information processing system according to claim 13,
wherein the information processing apparatus further includes
a capturer configured to capture the part-selecting image displayed on the display in order to obtain an image, on the part-selecting image the instructing operation point being indicated by use of an instructing operation device, and
wherein the specifying unit specifies the display part on which the instruction operation is performed, based on the image obtained by the capturer and part-selecting image arrangement information indicating an arrangement of the one or more display parts included in the part-selecting image.

15. The information processing system according to claim 14,
wherein the specifying unit detects a coordinate of the instructing operation point appearing on the image obtained by the capturer, and then specifies the display part on which the instruction operation is performed, based on the detected coordinate, resolution of the captured image, resolution of the part-selecting image, and the part-selecting image arrangement information.

16. A method for processing information performed in an information processing system including an information processing apparatus and a display device, the method comprising
by the information processing apparatus,
sending, to the display device, part-selecting image information provided displaying a part-selecting image including one or more display parts, and
sending, to the display device, a function executing instruction for executing a function corresponding to one of the one or more display parts, the one of the one or more display parts being specified by an instructing operation performed on the part-selecting image displayed on a display by the display device, and
by the display device,
receiving the part-selecting image information from the information processing apparatus,
displaying the part-selecting image on the display, based on the received part-selecting image information,
receiving the function executing instruction from the information processing apparatus, and
executing the function in accordance with the received function executing instruction.

17. A computer program product for being executed on a computer, the computer program product comprising:
an image information sender configured to send, to display device, part-selecting image information provided for displaying a part-selecting image including one or more display parts; and
a function executing instruction sender configured to send, to the display device, a function executing instruction for executing a function corresponding to one of the one or more display parts, the one of the one or more display parts being specified by an instructing operation performed on the part-selecting image displayed on a display by the display device.
